(19) United States
(12) Patent Application Publication
(10) Pub. No.: US 2026/0090956 A1
(43) Pub. Date: Apr. 2, 2026

(54) MEDICAL DEVICE

(71) Applicant: IAMM Health Limited, Cork (IE)

(72) Inventors: Mahmoon Ur Rashid, West Yorkshire (GB); Benjamin Richard Whiteside, Pudsey (GB); Dermot Hanafin, Vilamoura (PT)

(73) Assignee: IAMM Health Limited, Cork (IE)

(21) Appl. No.: 19/340,191

(22) Filed: Sep. 25, 2025

(30) Foreign Application Priority Data
Sep. 27, 2024 (GB) 2414203.6
Jul. 7, 2025 (GB) 2510964.6

(51) Int. Cl. A61J 1/20; A61J 1/14

(52) U.S. Cl. CPC A61J 1/2093; A61J 1/1406; A61J 1/1412; A61J 1/2048; A61J 1/2096

(57) ABSTRACT

A drug storage and mixing device including a tube defining a cavity, and a plug disposed within the cavity. The plug divides a first unsealed space extending from a first end of the cavity to the plug, from a second sealable space extending from a second end of the cavity to the plug. The second sealable space sealably accommodates a drug and/or an excipient. The plug is translatable along a longitudinal axis of the tube while maintaining a seal with an inner surface of the tube, for reversibly changing the volume of the second sealable space. The first end of the cavity includes an unsealed aperture, whereas the second end of the cavity includes a shoulder extending inwardly to a connection and sealing mechanism. The connection and sealing mechanism has a connector and a sealing element. A kit includes the drug storage and mixing device and a medical syringe.

### CROSS-REFERENCE TO RELATED APPLICATIONS

This application is related and claims priority to GB Application No. 2510964.6, filed Jul. 7, 2025, titled “MEDICAL DEVICE,” which claims priority to GB Application No. 2414203.6, filed Sep. 27, 2024, titled “MEDICAL DEVICE,” the entire disclosures of all of which are incorporated herein by reference for all purposes.

### FIELD OF THE DISCLOSURE

The present disclosure concerns drug storage and mixing devices. The disclosure also concerns related kits and methods of using the devices and kits.

### BACKGROUND

Medical procedures, both emergency and elective, may require the mixing of a solid drug, for example a lyophilised solid drug, with a liquid vehicle in a precise ratio, immediately prior to injecting a patient with the reconstituted mixture. Achieving full dissolution may require mixing the liquid into the solid in stages. This may be performed by injecting a few millilitres of liquid at a time into a milligrams amount of solid contained in a vial. In some situations, multiple dispensing needles are used in multiple mixing steps. The required drug may be stored in a glass ampoule. To access the drug, there is a step of breaking the neck of the glass ampoule.

### SUMMARY OF THE DISCLOSURE

In accordance with a first aspect, the present disclosure provides a device for storing and/or mixing one or more drugs (such as a drug storage and/or mixing device), the device comprising a tube defining a cavity extending from a first end to a second end; the device further comprising a plug having a first surface, a second surface and at least one peripheral sealing surface therebetween, the peripheral sealing surface forming an intermediate moveable seal within the cavity, the plug thereby dividing a first unsealed space extending from the first end of the cavity to the first surface of the plug, from a second scalable space extending from the second surface of the plug to the second end of the cavity, wherein the second scalable space is configured for sealably accommodating a drug and/or an excipient, wherein the plug is translatable along a longitudinal axis of the tube while maintaining a seal with an inner surface of the tube (i.e. the plug is sealably translatable along the longitudinal axis of the tube), for reversibly changing the volume of the second scalable space (which may change the volume ratio of the first unsealed space to the second sealed space), wherein the first end of the cavity is defined by an unsealed aperture, whereas the second end of the cavity is defined by a shoulder extending inwardly to a connection and sealing mechanism, the connection and sealing mechanism comprising a connector and a scaling element.

The second scalable space may contain an openable internal seal extending across the interior of the tube. The internal seal may have a first surface and a second surface. The internal seal may be disposed between the second surface of the plug and the second end of the device. The first surface of the internal seal may face the second surface of the plug. The second surface of the internal seal may face the second end of the device.

The internal seal may be breakable, for example rupturable (i.e. the seal may be opened by being broken (e.g. ruptured)). The internal seal may be configured to break (e.g. rupture) in response to a difference in air pressure acting on the first surface of the seal relative to the second surface of the seal. The internal seal may be configured to break (e.g. rupture) in response to an increase in fluid pressure (e.g. air pressure) applied via the second end of the cavity. The internal seal may be substantially disk shaped. The internal seal may be in the form of a rupturable disk. The internal seal may comprise one or more frangible regions. The one or more frangible regions may be configured to preferentially break (e.g. rupture) in response to said increase in fluid pressure.

A third space may be defined as between the second surface of the internal seal and the second end of the device. The third space may be configured for sealably accommodating the excipient and/or the drug; especially the drug. Thus, the third space, when present, is a scalable (or scaled) space.

The device may comprise a storage configuration, for example in which the device is used to store and transport a drug and/or excipient. The device may comprise a mixing configuration, for example in which the device is used to mix the drug and excipient.

Optionally, in the storage configuration of the device, the first surface of the internal seal is flush with the second surface of the plug (without a gap therebetween). It may be preferred, if so, that the third scalable space is configured for sealably accommodating the drug.

In an alternative storage configuration of the device, a fourth scalable space is defined as between the second surface of the plug and the first surface of the internal seal. The fourth scalable space may be configured for sealably accommodating the excipient and/or the drug; especially, the excipient. Thus, the fourth scalable space, when present, is a scalable (or scaled) space. It may be preferred, if so, that the third scalable space is configured for sealably accommodating the drug and the fourth scalable space is configured for sealably accommodating the excipient. In the mixing configuration of the device, the internal seal may be open (e.g. broken, ruptured).

Optionally, the internal seal is absent. When the internal seal is absent, the second space may preferably be configured for sealably accommodating the excipient and/or the drug; especially the drug.

Where a scalable space (second, third or fourth scalable space) is configured for scalably accommodating, or sealably accommodates, the drug, it will be understood that in the storage configuration of the device said space is configured to exclude, or excludes, the excipient. Similarly, where a sealable space (second, third or fourth scalable space) is configured for sealably accommodating, or sealably accommodates, the excipient, it will be understood that in the storage configuration of the device said space is configured to exclude, or excludes, the drug.

In the storage configuration, a first drug and/or excipient may be sealed within the second scalable space. The first drug and/or excipient may be sealed on one side by the second surface of the plug. The tube may comprise a neck portion. The first surface of the plug may comprise a projection configured to form an interference fit with the neck portion. The first drug and/or excipient may be sealed on one side by the internal seal, for example the second surface of the internal seal. The first drug and/or excipient may be sealed on the other side by the sealing element. The first drug and/or excipient may be sealed on the other side, when the drug and/or excipient are in solid form (although not when they are dissolved in a solute), by a filter. A second drug and/or excipient may be sealed within the second scalable space. The second drug and/or excipient may be sealed between the second surface of the plug and the internal seal, for example the first surface of the internal seal.

The tube may comprise a first chamber within which the plug can travel, and a second chamber into which the plug is prevented from travelling. The second chamber may provide a storage space for the storage of drug and/or excipient, for example while the device is in a storage configuration. The second chamber may be between the first chamber and the connector. The second chamber may be defined within the neck portion of the tube. The neck portion may be a portion of reduced internal diameter in comparison to the internal diameter of the portion of the tube in which the plug travels. The shoulder of the tube may be a second shoulder. The second shoulder may be between a first shoulder and the connection and sealing mechanism. The neck portion may be between the first shoulder and second shoulder. The second chamber may be between the first shoulder and the second shoulder.

The second chamber may have a greater internal diameter than the internal diameter of the connector. For example, the internal diameter of the second chamber may be at least twice, or at least three times, or at least four times the internal diameter of the connector. The second chamber may have a greater internal cross-sectional area (and/or internal volume) than the internal cross-sectional area (and/or internal volume) of the connector. For example, the internal cross-sectional area (and/or internal volume) of the second chamber may be at least five times, or at least ten times, or at least twenty times the internal cross-sectional area (and/or internal volume) of the connector. The second chamber may have an internal diameter of at least 4 mm, at least 5 mm, or at least 6 mm. The second chamber may have an internal cross-sectional area of at least 10 mm², at least 20 mm², or at least 30 mm². The second chamber may have an internal volume of at least 0.05 ml, at least 0.1 ml, at least 0.2 ml, at least 0.5 ml, or at least 1 ml.

In the storage configuration, the first drug or excipient may be sealed within the second chamber. The second chamber may be sealed on one side by the sealing element and/or filter in the manner described above. The second chamber may be sealed on the other side by the second surface of the plug or by the internal seal in the manner described above. The second drug or excipient may be sealed within the first chamber between the second surface of the plug and the internal seal.

When the device is in a storage configuration, the drug may be encapsulated within an encapsulation material. The encapsulation material may form a barrier around the drug. The barrier may isolate the drug from the remainder of the second scalable space. The barrier of encapsulation material may extend completely around the drug. Alternatively, the drug may be encapsulated between the encapsulation material and the plug (e.g. the second surface of the plug). The drug may be attached to the plug and/or tube via the encapsulation material. For example, in a manner that the device can be inverted and the drug remains in position. For example, the encapsulation material may bond to the plug and/or tube. The encapsulation material may be soluble in the excipient, preferably such that the encapsulation material dissolves within the excipient during mixing.

The Drug(s) of the Device for Storing and/or Mixing a Drug (Such as a Drug Storage and Mixing Device)

The device is a device for storing and/or mixing a drug. Preferably, the device is a drug storage and mixing device. Thus, the device is preferably configured for the storage of at least one drug; and/or at least one excipient. The device may be configured for mixing the drug and/or the excipient with another substance. The other substance may be or comprise one or more excipients and/or one or more further drugs. Suitably, the device is configured for storing a drug and excipient and for mixing said (same) drug and said (same) excipient. Optionally, in some implementations, the device may be used as a drug and/or excipient storage device without being used for drug mixing.

The drug may be a solid. The drug may preferably be or comprise a lyophilised (i.e., freeze-dried) solid. Freeze drying of the drug may be in accordance with ASTM E3250. The drug may be or comprise a crystalline solid. The drug may be or comprise an amorphous solid. Alternatively, the drug may be a liquid. The liquid may be a solution, a mixture (such as an emulsion) or a pure liquid.

The drug may be or comprise any drug that is suitable for, or requires, mixing and/or reconstituting prior to administration to a patient in need thereof. Thus, the drug may be or comprise any drug in a powder dosage form for storage and/or for reconstitution by mixing with liquid (such as saline). For similar reasons, the drug may be or comprise any liquid drug (encompassing solutions and pure liquids) for storage and/or mixing.

The drug may be or comprise any drug that is suitable for, or requires, mixing and/or reconstituting prior to injection or oral administration, especially injection, to a patient in need thereof. Thus, the device may be a storage and mixing device for an injectable drug.

The drug may be or comprise one or more polymers. The drug may be or comprise one or more peptides or one or more proteins (such as one or more glucagon-like peptide-1 receptor agonists, e.g. semaglutide; or such as insulin), especially one or more enzymes. The drug may be or comprise hyaluronidase, adrenaline, benzylpenicillin, insulin, glucagon, or a pharmaceutically acceptable salt or solvate thereof. Preferably, the drug is or comprises hyaluronidase or a pharmaceutically acceptable salt or solvate thereof.

The drug may be or comprise one or more nucleic acids, such as DNA or RNA. The drug may be or comprise mRNA or siRNA. In its broadest sense, the term “DNA” encompasses any deoxyribonucleic acid, a polymer composed of two polynucleotide chains that coil around each other to form a double helix. In its broadest sense, the term “siRNA” encompasses small interfering RNA, comprising RNA molecules which operate within the RNA interference (RNAi) pathway. siRNA is sometimes known as short interfering RNA or silencing RNA. The siRNA may be double stranded. The siRNA may have a length in a range of from about 5 to about 50 base pairs. In its broadest sense, the term “mRNA” encompasses messenger RNA for the synthesis of protein(s). It may encompass mRNA comprising a 5-prime cap and/or a poly-adenylated terminus. Alternatively, one or both of those features may be absent. Typically, the mRNA may be single stranded. The coding region of the mRNA may be at least about 500 bases in length. RNA and DNA may be naturally occurring or chemically modified to enhance their therapeutic properties, such as enhanced activity, increased serum stability, reduced off-targeting and lower immunological activation. Chemical modifications to RNA and DNA may include any modifications commonly known in the art. As used herein, the term “naturally occurring” means of natural human or animal origin. It will be understood that a molecular structure that is the same as a naturally occurring molecular structure may nevertheless be synthesized in vitro, such as when mRNA is synthesized by in vitro transcription (IVT).

The drug may be or comprise one or more antiviral agents (such as neuraminidase inhibitors) or a pharmaceutically acceptable salt or solvate thereof; such, for example, as oseltamivir, zanamivir, peramivir, baloxavir marboxil, or a pharmaceutically acceptable salt or solvate thereof.

The drug may be or comprise one or more antibiotics (such as penicillins, macrolides, cephalosporins, fluoroquinolones, beta-lactams, lincosamides, tetracyclines, sulfonamides, glycopeptides, aminoglycosides or monobactams) or a pharmaceutically acceptable salt or solvate thereof. The drug may be or comprise one or more cystic fibrosis drugs (such as one or more antibiotics to prevent or treat chest infections, one or more mucus thinning drugs, one or more bronchodilators or one or more steroids) or a pharmaceutically acceptable salt or solvate thereof. The drug may be or comprise aztreonam or a pharmaceutically acceptable salt or solvate thereof.

The drug may be or comprise one or more antifungal agents (such as polyenes, azoles, allylamines or echinocandins) or a pharmaceutically acceptable salt or solvate thereof. The drug may be or comprise Amphotericin B or a pharmaceutically acceptable salt or solvate thereof.

The drug may be or comprise one or more immunotherapeutic agents (such as one or more checkpoint inhibitors including PD-1 and CTLA-4 checkpoint inhibitors, one or more cytokines including IL-2 and INF-alpha, or one or more cancer vaccines) or a pharmaceutically acceptable salt or solvate thereof. The drug may be or comprise sacituzumab govitecan or a pharmaceutically acceptable salt or solvate thereof.

The drug may be or comprise one or more anti-cancer drugs. Thus, the drug may be or comprise one or more anti-metabolite type drugs, such as: one or more purine antagonists, one or more pyrimidine antagonists, and one or more antifolates; or pharmaceutically acceptable salts or solvates thereof. The drug may be or comprise one or more of: 5-fluorouracil, azacitidine, capecitabine, cladribine, clofarabine, cytarabine, decitabine, floxuridine, fludarabine phosphate, gemcitabine, hydroxyurea, methotrexate, nelarabine, pralatrexate, an inhibitor of dihydrofolate reductase, and pemetrexed; or pharmaceutically acceptable salts or solvates thereof.

The drug may be or comprise one or more hormones and/or one or more steroids; or pharmaceutically acceptable salts or solvates thereof. The drug may be or comprise one or more corticosteroids (especially glucocorticoids, such as cortisol; and/or mineralocorticoids, such as aldosterone), one or more sex steroids (such as one or more progestogens, e.g. progesterone; one or more androgens, e.g. testosterone; and/or one or more estrogens, e.g. estradiol) and/or one or more neurosteroids; or pharmaceutically acceptable salts or solvates thereof.

The drug may be anti-infective, for example the drug may be or comprise one or more of: (i) antibiotics for example: β-lactams (e.g. penicillins, cephalosporins, carbapenems, monobactams), macrolides (e.g. erythromycin, azithromycin), tetracyclines (e.g. doxycycline, minocycline), aminoglycosides (e.g. gentamicin, amikacin), fluoroquinolones (e.g. ciprofloxacin, levofloxacin), glycopeptides (e.g. vancomycin, teicoplanin), clindamycin, linezolid, daptomycin; (ii) antivirals for example: HIV therapies (e.g. NRTIs, NNRTIs, protease inhibitors, integrase inhibitors), hepatitis drugs (e.g. sofosbuvir, entecavir), herpes drugs (e.g. acyclovir, ganciclovir), influenza drugs (e.g. oseltamivir, zanamivir); (iii) antifungals for example: azoles (e.g. fluconazole, itraconazole), polyenes (e.g. amphotericin B), echinocandins (e.g. caspofungin, micafungin); (iv) antiparasitics for example: antimalarials (e.g. artemisinin, chloroquine), antihelminthics (e.g. albendazole, ivermectin), antiprotozoals (e.g. metronidazole).

The drug may be an oncology and/or immunology drug, for example the drug may be or comprise one or more of: (i) cytotoxic chemotherapies for example: alkylating agents (e.g. cyclophosphamide, ifosfamide), antimetabolites (e.g. methotrexate, 5-FU), anthracyclines (e.g. doxorubicin), taxanes (e.g. paclitaxel, docetaxel), platinum agents (e.g. cisplatin, carboplatin); (ii) targeted therapies for example: tyrosine kinase inhibitors (e.g. imatinib, erlotinib), PARP inhibitors (e.g. olaparib); (iii) immunotherapies for example: checkpoint inhibitors (e.g. pembrolizumab, nivolumab), CAR-T therapies; (iv) monoclonal antibodies and/or biologics for example: anti-TNF, anti-IL, anti-VEGF; (v) immunosuppressants for example; calcineurin inhibitors (e.g. cyclosporine, tacrolimus), mTOR inhibitors (e.g. sirolimus).

The drug may be a cardiovascular drug, for example the drug may be or comprise one or more of: (i) antihypertensives for example: ACE inhibitors (e.g. ramipril), ARBs (e.g. losartan), beta-blockers (e.g. metoprolol), calcium channel blockers (e.g. amlodipine), diuretics (e.g. loop (e.g. furosemide), thiazide (e.g. bendroflumethiazide), K-sparing (e.g. spironolactone); (ii) antiarrhythmics for example: class I: sodium channel blockers, class II: beta-blockers, class III: K+ blockers (amiodarone), class IV: calcium channel blockers; (iii) antithrombotics for example: antiplatelets (e.g. aspirin, clopidogrel), anticoagulants (e.g. heparin, LMWH, DOACs, warfarin), thrombolytics (e.g. alteplase, streptokinase), lipid-lowering (e.g. statins, fibrates, PCSK9 inhibitors).

The drug may be a neurology drug, for example the drug may be or comprise one or more of: (i) analgesics for example: opioids (e.g. morphine, fentanyl, hydromorphone), NSAIDs (e.g. ketorolac, diclofenac), adjuvants (e.g. gabapentin, amitriptyline; (ii) anesthetics for example: general (e.g. propofol, ketamine, volatile agents), local (e.g. lidocaine, bupivacaine); (iii) antidepressants for example: SSRIs, SNRIs, TCAs, MAOIs; (iv) antipsychotics for example: typical (e.g. haloperidol), atypical (e.g. olanzapine, risperidone); (v) mood stabilizers for example: lithium, valproate, lamotrigine; (vi) anticonvulsants for example: carbamazepine, levetiracetam, phenytoin, (vii) stimulants for example: methylphenidate, amphetamine salts; (viii) neurodegenerative for example: levodopa, dopamine agonists, MAO-B inhibitors, donepezil, memantine; (ix) sedatives and hypnotics for example: benzodiazepines, Z-drugs.

The drug may be an endocrine and/or metabolic neurology drug, for example the drug may be or comprise one or more of: (i) diabetes drugs for example: insulin formulations (e.g. short-, intermediate-, long-acting), non-insulin injectables (e.g. GLP-1 agonists), oral agents (e.g. metformin, sulfonylureas, DPP-4 inhibitors, SGLT2 inhibitors); (ii) thyroid drugs for example: levothyroxine, carbimazole; (iii) adrenal for example: glucocorticoids (e.g. hydrocortisone, dexamethasone), mineralocorticoids (e.g. fludrocortisone); (iv) sex hormones for example: estrogen, progesterone, testosterone, contraceptives; (v) growth hormones for example: somatropin.

The drug may be a respiratory drug, for example the drug may be or comprise one or more of: (i) bronchodilators for example: short-acting β2-agonists (e.g. salbutamol), long-acting β2-agonists (e.g. salmeterol), antimuscarinics (e.g. ipratropium, tiotropium); (ii) anti-inflammatory for example: inhaled corticosteroids, leukotriene antagonists, biologics for asthma (e.g. omalizumab, mepolizumab).

The drug may be a gastrointestinal drug, for example the drug may be or comprise one or more of: acid suppressants (e.g. PPIs, H2 blockers), prokinetics (e.g. metoclopramide, domperidone), laxatives (e.g. osmotic, stimulant, bulk-forming), antiemetics (e.g. ondansetron, cyclizine, metoclopramide), IBD therapies (e.g. 5-ASA (e.g. mesalazine), steroids, biologics (e.g. anti-TNF).

The drug may be a renal and/or urology drug, for example the drug may be or comprise one or more of: diuretics, erythropoiesis stimulating agents, alkalinizers/acidifiers, drugs for BPH (e.g. α-blockers, 5α-reductase inhibitors).

The drug may be a hematology drug, for example the drug may be or comprise one or more of: erythropoietin analogues, iron therapies (e.g. IV iron sucrose, ferric carboxymaltose), colony stimulating factors (e.g. filgrastim, pegfilgrastim), blood products (e.g. albumin, clotting factors, immunoglobulins).

The drug may be a vaccine, for example the drug may be or comprise one or more of: a live attenuated vaccine, an inactivated vaccine, an mRNA vaccine, protein subunit, a viral vector vaccine.

The drug may be or comprise one or more of: biologics, biosimilars, gene therapies, nutraceuticals (e.g. vitamins, minerals, amino acids), antidotes (e.g. naloxone, flumazenil, N-acetylcysteine, atropine, digibind).

Alternatively or additionally stored within the second scalable space is one or more of: radiopharmaceuticals (e.g. technetium-99m, iodine-131), contrast agents (e.g. iodinated, gadolinium).

The second scalable space may be configured for sealably accommodating the drug. A solid (optionally, lyophilised) drug may be accommodated in the second scalable space. A liquid drug may be accommodated in the second scalable space. The third and/or fourth scalable space (especially, the third scalable space) may be configured for scalably accommodating the drug. The device may contain the drug. The drug may be sealably accommodated in the second scalable space of the device. The drug may be sealably accommodated in the third and/or fourth scalable space (especially, the third scalable space) of the device. As used herein, the term “sealable” and its derivatives may be used to refer to a space being watertight and/or airtight (e.g., hermetically sealed) in a closed configuration of the device, but which is in fluid communication with the surroundings in an open configuration of the device.

The device may be an emergency device. The simplicity, stability and low sharps risk of the device may enable it to be used in emergency procedures at low risk. Thus, the device may be a device for the storage and mixing of a drug (especially, hyaluronidase) for use in emergency procedures. The emergency device may contain the drug (especially, hyaluronidase).

The device may be sized for the storage and mixing of (and may thus contain) about 1 mg to about 5 g, about 1 mg to about 2 g, or about 1 mg to about 100 mg of the drug. The device may be sized for the storage of (and in use, may contain) a defined amount of the drug. In particular, the device may be sized for the storage of (and in use, may contain) a defined number, especially an integer number, of dosage units of the drug; such as 1, 2, 3, 4 or 5 dosage units. This may increase the certainty of the correct amount of the drug being administered by a physician even when the physician is working quickly.

As used herein, the term “drug” may mean a composition containing at least one active pharmaceutical and/or cosmetic ingredient (also known in the art as an API and an ACI, respectively). The drug may contain (in addition to the at least one API and/or ACI) one or more excipients, such as one or more of: fillers, colourants, sorbents, preservatives, vehicles, lubricants, glidants and anti-adherents.

### Excipient

As used herein, the term “excipient” has its usual meaning in the art. An excipient is a substance for mixing with a drug. An excipient is not a drug. An excipient is a therapeutically inert substance (it does not have a therapeutic effect), preferably a physiologically inert substance (it does not have any physiological effect, therapeutic or otherwise).

The second sealable space may be configured for sealably accommodating an excipient. The fourth sealable space may be configured for sealably accommodating an excipient. The device may contain the excipient. The excipient may be sealably accommodated in the second sealable space of the device. The excipient may be sealably accommodated in the fourth sealable space of the device.

The excipient may be liquid (e.g. a diluent), solid or semi-solid; especially liquid, most especially a solution (such, for example, as a saline solution). The excipient may be or comprise one or more solvents, one or more co-solvents, one or more preservatives, one or more flavouring agents and/or one or more viscosity enhancers. The excipient may be or comprise (pure) water, dextrose solution in water, local anaesthetics (e.g. lidocaine), bacteriostatic saline, bacteriostatic water, buffers, Hartmann's solution, ethanol, propylene glycol, glycerine, polyethylene glycol, one or more macrogols, dimethyl sulfoxide, benzyl alcohol, methylparaben, propylparaben, phenol, sorbitol, sucrose, xanthan gum, hydroxyethylcellulose and/or carboxymethylcellulose sodium.

### Materials for Forming the Device

The device may be made of or comprise one or more plastics, such as one or more of polycarbonate (PC), cyclic olefin copolymer (COC), polyethylene (PE), polypropylene (PP), polyvinylchloride (PVC), polyethyleneterephthalate (PET), polyvinylidenechloride (PVDC), epoxy and polyester; especially COC.

If the device comprises the one or more plastics (especially, COC), the one or more plastics may form at least about 50, 60, 70 or 80% by weight of the device.

The material of the device (such as the one or more plastics) is preferably inert. It preferably excludes compounds capable of leaching out of the material, and preferably is or comprises one or more non-leachable plastics, such as one or more of non-leachable PC, COC, PE, PP, PVC, PET, PVDC, epoxy or polyester, especially non-leachable COC.

The material of the device may exclude glass. The exclusion of glass (such as by its replacement with one or more plastics) may reduce the sharps risk of the device compared to traditional glass devices.

Nevertheless, the material of the device may in some instances include glass. Glass may be used, for example, when the drug is or comprises a protein, such as an enzyme; or a nucleic acid, such, for example, as DNA or RNA, such as mRNA or siRNA. Glass may be suited to storage at low temperatures. Glass may be tinted to prevent the entry of UV to the second scalable space, thus preventing degradation of the drug by UV.

### The Tube of the Device

The device comprises a tube defining a cavity extending from a first end to a second end.

The tube of the device may be made of or comprise the one or more plastics described herein, such as one or more of COC, PP, PE, PVC, PET, PVDC, epoxy and polyester. If the tube comprises the one or more plastics, the one or more plastics (especially, COC) may form at least about 50, 60, 70 or 80% by weight of the tube. The tube may consist substantially of the one or more plastics.

The tube has an inner surface. The inner surface may comprise a coating. The tube or the coating may be formed of or comprise one or more rubbers or other polymers, such as one or more of: natural (e.g. Hevea Brasiliensis) rubber, silicone, butyl rubber, neoprene, butyl rubber, EPDM rubber, nitrile rubber, polyurethane, FKM or FPM rubber, and styrene-butadiene; preferably butyl rubber, silicone or polyurethane, especially silicone (as used herein, the term silicone means polysiloxane). This may assist in providing an appropriate coefficient of friction as between the inner surface of the tube and the peripheral sealing surface of the plug, described herein.

The inner surface of the tube is preferably uninterrupted all the way from the first end of the cavity to the second end. This may mean that surface features (especially, protrusions, ridges, rims, holes, cavities or other surface interruptions) are absent from the inner surface of the tube.

The inner surface of the tube preferably has a substantially constant or constant cross-sectional shape and a substantially constant or constant cross-sectional diameter along the entire length of the tube from the unsealed aperture, defining the first end of the cavity of the tube, to where the shoulder, defining the second end of the cavity, begins.

The device may be configured to stand upright (i.e., on end) and unsupported (i.e., without being held by a user) upon a part of the tube that defines the first end of the cavity. Configuring the device to stand upright and unsupported (on a substantially flat surface) has been found to enable easier handling by a physician.

The height to diameter ratio of the tube of the device may be such as to confer stability when the device is configured to stand upright and unsupported as described herein. Additionally or alternatively, the ratio may be such as to increase the responsiveness of the plug to changes in pressure. It has been found that a squatter aspect ratio may result in applied pressure generating greater axial force on the plug, so that the plug can be displaced more readily along the longitudinal axis of the tube in response to relatively small pressure differentials.

Thus, the height and diameter of the tube may be of the same order of magnitude. The height and diameter of the tube may be within about 1 cm to about 10 cm of each other. The height to diameter ratio of the tube may be less than or equal to 8:1, 4:1, 2:1, or 1.5:1 (i.e. it may be that height/diameter ≤8, 4, 2, or 1.5). The height to diameter ratio of the tube may be in a range of from about 1:4 to about 8:1, or about 1:4 to about 4:1, especially 1:2 to about 4:1; such as about 1:2 to about 2:1, especially about 1:1.5 to about 1.5:1; e.g., about 1:1. It will be understood that the diameter of the tube may be the outermost diameter of the outwardly extending flange on the exterior of the tube at the first end, as described herein, if the flange is present. It will also be understood that the height of the tube may be from the first end of the cavity to the second end of the cavity inclusive of the height of the connector and, if present, of the collar encircling the connector, as described herein. It will be understood that the diameter of the tube may be measured in a direction transverse to the height.

The length of the tube, from the first end to the second end, may be about 2 cm to about 15 cm, such as about 2 cm to about 10 cm, such as about 2 cm to about 8 cm. The tube may have a mean diameter of about 1 cm to about 10 cm, such as about 2 cm to about 10 cm, such as about 2 cm to about 8 cm.

### The Plug of the Device

The device comprises a plug. Preferably, the plug is housed entirely within the tube (during both storing and mixing, although it may approach either end of the tube, particularly during mixing).

The first surface of the plug may be bounded by and extend inwardly from a substantially circular perimeter. The second surface of the plug may be bounded by and extend inwardly from a substantially circular perimeter. The first and second surfaces of the plug preferably have substantially the same mean diameter as each other. It will be appreciated that the first and second surfaces may nevertheless be three dimensional, for example being convex or concave, as described herein. The plug may be substantially disc shaped.

The plug is not a syringe plunger, nor is it configured to form part of a syringe plunger. The plug may exclude components typically found in a syringe plunger. The plug may exclude any component (such as a handle) for directly pushing and pulling the plug by hand. As described, the plug preferably sits entirely within the tube. Therefore, preferably, no part of the plug is exposed outside of the tube. This may include any extension of or from the plug, and may include any parts which move with the plug, except, in certain embodiments, the attachable handle described herein for removing the plug from the tube.

The plug may be, or may be configured to be, suspended entirely within the cavity of the tube, with the first surface of the plug being spaced apart from the first end of the cavity. Preferably, the plug is, or is configured to be, suspended in this way in an unchanging storage position, until the device is used for mixing.

The plug is preferably a self-suspending plug. In other words, the plug preferably is, or is configured to be, suspended in the cavity solely by a friction fit between the peripheral scaling surface and the inner surface of the tube. Preferably, the plug is, or is configured to be, suspended in this way in an unchanging storage position, until the device is used for mixing.

The plug is preferably not supported by any other structural element interior to the tube, such as a lip, rim, flange or other supportive element.

Nor would the plug rest on the drug (when present) and/or excipient (when present) in turn resting on the shoulder defining the second end of the cavity. Instead, the plug is preferably configured to support the weight of a drug and/or an excipient resting on its second surface without the plug slipping down the tube.

The plug is preferably configured for supporting the weight of a drug and/or an excipient while remaining so suspended. The plug may therefore be configured to remain stationary and suspended in the tube when its second surface bears the weight of a drug and/or an excipient, by means of the friction fit between the peripheral sealing surface and the inner surface of the tube.

The described features may prevent or mitigate undesirable compaction of the drug during storage. Avoiding or mitigating compaction of the drug may mean that drug mixing takes far less time, and the resultant mixture is more homogenous (especially important for drugs administered by injection) because the drug is more readily dispersible.

The described features may also provide an especially simply manufactured device. It has been found that the components required to put the device together are simple and easy to form from a variety of materials, including from the preferred materials described herein, such as one or more of the plastics described herein. The increased simplicity of the device also enables easier handling by a physician.

All in all, the plug may be configured to move only during mixing, while remaining stationary during storage. During drug mixing, as described herein, the plug may be made, indirectly, to move. Thus, the plug is suitably configured to sit stationary, suspended by friction alone and entirely within the tube, preferably by balancing the weight of the plug (and, if/when present, the weight of the drug and/or of the excipient) against the friction between the peripheral scaling surface and the inner surface of the tube, until a negative or positive pressure is applied via the connector, as described herein, such as in operation of the plunger of the syringe as defined in accordance with the second aspect of the disclosure. Preferably, there is present no structural supporting element (such as a lip or rim) holding the plug in place in the tube. Advantageously, this may enable more options for mixing, such as a more variable mixing volume in the second scalable space. It may mean that the same components can be assembled to form a device capable of storing various different volumes of drug, without remanufacturing different components of different sizes, simply by placing the plug at a different position within the tube, rather than by varying the volume of the tube itself.

In a storage configuration of the device, the position in which the plug is suspended in the tube may be fixed. However, its position may be adjustable during manufacture, so as to vary the amount of drug to be stored in the second scalable space, and/or the amount of mixture (such as liquid) the second scalable space can accommodate during mixing, without varying the tube cavity volume. The plug position, in a storage configuration of the device, may be set closer to the first than the second end of the tube, thereby increasing the volume of the second scalable space; such, for example, as when it is desired to store (and mix) a larger volume of drug (and/or a larger volume of excipient) without changing the overall dimensions of the device. The plug position, in a storage configuration of the device, may be set closer to the first than the second end of the tube, thereby decreasing the volume of the second scalable space; such, for example, as when it is desired to store (and mix) a smaller volume of drug (and/or a smaller volume of excipient) without changing the overall dimensions of the device. This may mean that the same components can be assembled to form a device capable of storing various different volumes of drug, without remanufacturing different components of different sizes.

The storage volume of the second scalable space may be established by placing the plug in a freestanding (i.e., unsupported) storage position. Advantageously, the plug may be placed (for example, during manufacture) at a precise storage position, depending on the amount of drug and/or excipient to be accommodated in the second scalable space. The plug may be placed (for example, during manufacture) at a precise storage position in dependence on the amount of mixture present during mixing (such as in dependence on the amount of a liquid to be mixed with the drug).

The plug may be placed at different positions such that about 1 ml, about 5 ml, about 10 ml, about 15 ml, about 20 ml, or about 25 ml of drug may be stored in the second scalable space of the device (such as in the third scalable space).

The plug may be placed at different positions such that about 1 ml, about 5 ml, or about 10 ml, or about 15 ml of an excipient (such as a liquid) may be mixed with the drug during use of the device.

The device may comprise a limiter configured to limit the travel of the plug towards the first end of the tube. The limiter may define an end position of the plug, beyond which the plug cannot travel further in a direction (e.g. an outward direction) from the second end of the tube towards the first end of the tube. The limiter may therefore define a maximum volume of the second scalable space (and the fourth scalable space, where present). The limiter may comprise a stopping surface configured to be contacted by the plug when at the end position.

The limiter may retain the plug within the tube. The limiter may retain the plug fully within the tube. The limiter may prevent the plug from travelling beyond a position in which the first surface of the plug is flush with the first end of the tube. The limiter may prevent the plug from travelling beyond a position in which the peripheral sealing surface, in whole or in part, breaks contact with the tube or otherwise fails to form a seal within the cavity.

The limiter may be adjustable such that the end position of the plug is adjustable. The limiter may thereby provide adjustment of the maximum volume of the second scalable space (and the fourth scalable space, where present). The limiter may comprise an indexing mechanism configured to provide adjustment of the end position of the plug between a plurality of indexed end positions. The indexing mechanism may bias the stopping surface to a plurality of indexed stopping positions, defining the plurality of indexed end positions of the plug (the stopping surface being biased to only one of the stopping positions at any one time). The indexed end positions are preferably regularly spaced. The indexed end positions may correspond to different predefined maximum volumes. The indexed end positions may correspond to different maximum volumes which are spaced, for example, at 1 ml, 2 ml, 2.5 ml, 5 ml, or 10 ml intervals.

The limiter may be in the form of a projection extending into the cavity from an inner wall of the tube. The projection may be ultrasonically welded to the tube. The limiter may be in the form of a cap provided at least partly over the first end of the tube. The limiter may form (e.g. a part of) a base of the device. The limiter may be adjustable by rotating at least part of the limiter relative to the tube. For example, the limiter may comprise a threaded part which, when rotated, causes the stopping surface to travel towards or away from the second end of the tube. The threaded part may rotate relative to a threaded portion of the tube, or relative to a threaded portion of a sleeve within the tube. The indexing mechanism may index the relative rotational position of the threaded part relative to the tube, for example by biasing the threaded part to a plurality of different rotational positions (the threaded part being biased to only one of those positions at any one time).

When the storage volume of the second scalable space is established by placing the plug in a freestanding storage position commensurate with a volume of drug to be contained in the second scalable space, the device may be configured to minimise the volume of air contained in the second scalable space with the drug and/or the excipient. This may be achieved by placing the plug in a storage position that limits the second scalable space to a volume identical or substantially identical to the volume of drug and/or excipient to be stored. Advantageously, minimising the volume of air in the second scalable space may promote drug and/or excipient stability.

The device may be configured to minimise the volume of air contained in the third scalable space alongside excipient and/or drug. In a storage configuration of the device, the plug and/or the internal seal may be placed in a position that limits the third scalable space to a volume identical or substantially identical to the volume of excipient and/or drug to be stored therein.

The device may be configured to minimise the volume of air contained in the fourth scalable space alongside excipient and/or drug. In a storage configuration of the device, the plug and/or the internal seal may be placed in a position that limits the fourth scalable space to a volume identical or substantially identical to the volume of excipient and/or drug to be stored therein.

Additionally or alternatively, minimising the volume of trapped air may mitigate or prevent the formation of air bubbles in mixing. Air bubbles may otherwise cause inaccuracies in the volume of drug administered to a patient in need thereof. Moreover, when the drug is subsequently administered by intravenous injection to a patient in need thereof, injection of air may lead to one or more air embolisms within blood vessels of the patient, putting the patient at risk of myocardial infarction, stroke and/or respiratory failure. Mitigating or avoiding this risk is advantageous.

The plug is preferably wider than it is long. The mean width of the plug across the tube may be at least about 2, 3, 4 or 5 times the mean length of the plug along the tube.

The mean length of the plug (this being the dimension of the plug along, i.e., parallel to, the length of the tube) is preferably smaller (such as about 2, 3, 4 or more times smaller) than the length of the tube.

Preferably, the mean length of the plug along the tube is smaller than the mean length of the first unsealed space (extending from the first end of the cavity to the first surface of the plug) along the tube. Preferably, the mean length of the plug along the tube is smaller than the mean length of the second sealable space (extending from the second surface of the plug to the second end of the cavity).

The plug may be hollow. Making the plug hollow may make it more lightweight, which may facilitate smoothness of movement while meaning the plug does not inadvertently slip, e.g. under gravity, out of a desired position. The plug may be defined by a hollow housing in which an inner cavity is entirely enveloped by the housing. The plug may be hollow in the sense that one of its surfaces is concave, defining a hollow dip open to the surroundings of the plug.

The plug may comprise or consist of one or more plastics. The plug may comprise or consist of one or more of COC, PP, PE, PVC, PET, PVDC, epoxy, polyester, rubber, and thermoplastic elastomers (TPEs) (which may include TPE-S (styrene block copolymers) and TPE-V (thermoplastic vulcanizates)). The plug may comprise or consist of glass (for example, when a particularly delicate drug, such as an enzyme, is to be stored in contact with the plug), although preferably, the plug excludes glass. This may reduce the weight of the plug while also reducing its sharps risk.

Optionally the plug forms no more than about 10, 30 or 50% by weight of the device.

One or both of the first and second surfaces of the plug may be substantially flat. One or both of the surfaces may be three dimensional.

One or both of the surfaces of the plug (preferably, the first surface of the plug, next to the first unsealed space) may be concave. One or both of the surfaces of the plug (preferably the second surface of the plug, next to the second sealable space for sealably accommodating a drug) may be convex.

Preferably, the second surface of the plug (next to the second sealable space for sealably accommodating a drug) is convex, such as having a domed, conical or frustoconical shape. The first surface of the plug may have a frustoconical shape.

Preferably, the first surface of the plug (next to the first unsealed space) is concave or substantially flat.

The first surface of the plug may take the inverse shape to the second surface of the plug. The second surface may be convex while the first surface is concave. This may promote more complete mixing of the drug, in use, such as by pushing drug towards the connector, while also facilitating smoother movement of the plug, such as by modulating the forces acting on the plug surface.

The plug second surface may preferably be made of an inert material, preferably not glass, and preferably one or more of non-leachable PE, PP, PVC, PET, PVDC, epoxy or polyester. The plug second surface may be coated to provide an inert contact with the drug (when present) and/or the excipient (when present); such, for example, as a fluoropolymer (such as polyvinylidene fluoride, ethylene tetrafluoroethylene or polytetrafluoroethylene) coating; or another polymer coating, such as a polyphenylene sulfide coating. However, it will be understood that the plug second surface may comprise or consist of glass (for example, when a particularly delicate drug, such as an enzyme, is to be stored in contact with the plug second surface).

The plug first surface material may be less limited, but it may suitably have the same features as the plug second surface.

The peripheral sealing surface of the plug forms an intermediate moveable seal within the cavity. Friction between the peripheral sealing surface of the plug and the tube (i.e., the inner wall of the tube) may enable the plug to sit otherwise unsupported in a fixed position entirely inside the tube during storage; but to move during mixing.

The peripheral sealing surface may be formed of or comprise one or more rubbers or other polymers, such as one or more of: natural (e.g. Hevea Brasiliensis) rubber, butyl rubber, silicone, neoprene, butyl rubber, EPDM rubber, nitrile rubber, polyurethane, FKM or FPM rubber, and styrene-butadiene; preferably butyl rubber, silicone or polyurethane, especially silicone.

The peripheral sealing surface, being between the first and second surfaces of the plug, may comprise a single gasket intermediate the first and second surfaces of the plug. The peripheral sealing surface may comprise more than one gasket. The peripheral sealing surface may comprise a first gasket proximate the first surface of the plug and a second gasket proximate the second surface of the plug. The or each gasket may be formed of or comprise sealing material, such as the one or more rubbers or other polymers described herein, preferably butyl rubber, silicone or polyurethane, especially silicone.

The peripheral sealing surface may be entirely or substantially covered by sealing material, such as the one or more rubbers or other polymers described herein, preferably butyl rubber, silicone or polyurethane, especially silicone.

Thus, the plug may have its first surface made of a (preferably inert) plastic such as TEP, TPE-S, TPE-V, COC, PP or PE (especially COC), its second surface made of a (preferably inert) plastic such as TEP, TPE-S, TPE-V, COC, PP or PE (especially COC), and the peripheral scaling surface made of or comprising one or more rubbers or other polymers, preferably butyl rubber, silicone or polyurethane, especially silicone; such as the peripheral sealing surface comprising the same—also preferably inert—plastic, such as TEP, TPE-S, TPE-V, COC, PP or PE (especially COC), defining most of the peripheral sealing surface, with one or more gaskets formed of butyl rubber, silicone or polyurethane defining the rest of the peripheral sealing surface.

As described, the weight of the plug (and, if present, the drug and/or the excipient) may be balanced against the friction between the peripheral sealing surface and the tube inner surface such that the plug sits substantially still inside the tube during storage and forms a seal at one end of the second sealable space for sealably accommodating a drug; but during mixing, the plug can be moved. Suitably, the plug is moveable in reversible sealed translation along the longitudinal axis of the tube upon the application of a positive or negative pressure via the connector of the device, such as in operation of the plunger of the syringe as defined in accordance with the second aspect of the disclosure.

A coefficient of friction of 1 means the frictional force is equal to the normal force. Preferably, the coefficient of friction between the inner surface of the tube, and the part (or parts) of the peripheral sealing surface in contact with the inner surface of the tube, is at least about 1. Thus, the coefficient of friction is suitably relatively high. This may help the plug to stay in place during storage, and only move when deliberately induced to do so during mixing. A number of materials are available for forming the peripheral sealing surface (and the inner surface of the tube) to provide such a coefficient of friction. These include various rubbers described herein, including silicone rubbers.

The plug is scalably translatable along a longitudinal axis of the tube, for reversibly changing the volume ratio of the first unsealed space to the second scalable space, suitably upon the application of a positive or negative pressure via the connector of the device. The peripheral sealing surface is accordingly configured for reversal of the direction of translation without interruption of its seal. Preferably, it is configured for multiple reversals, such as more than about 5, 10, 20 or 30 reversals. The or each of the one or more gaskets (if present) of the peripheral sealing surface may thus be shaped for reversal of the direction of translation without interruption of their seal or seals, such as by having rounded gasket edges.

The plug may be connectable to a handle for removing the plug from the cavity. The handle may be configured to enable the plug to be pulled from the first end of the cavity. The plug and handle may comprise mutually engaging connection features configured to (removably) connect the handle to the plug. The first surface of the plug may comprise a first connection feature, and the handle may comprise a corresponding second connection feature configured to engage with the first connection feature so as to (removably) connect the handle to the plug. Various types of suitable mutually engaging connection features will be apparent to those skilled in the art. For example, the first connection feature may be a female screw thread, and the second connection feature may be a male screw thread, or vice versa. The first connection feature may be an undercut region, and the second connection feature may be a pin having lateral projections configured to be received within the undercut region, and vice versa. The first connection feature may be a loop, and the second connection feature may be a hook, and vice versa. The handle may project beyond the first end of the cavity, even when the plug is fully towards the connection and scaling mechanism end of the tube.

### The First Unsealed Space and its Unsealed Aperture

The first unsealed space extends from the first end of the cavity to the first surface of the plug. The first unsealed space is open to the surroundings of the device, while being entirely within the tube. At least a part of the sides of the first unsealed space may be defined by the inner surface of the tube, while at least another part of the sides of the first unsealed space is defined by the first surface of the plug and the plug suitably sits entirely within the tube, the plug being suspended solely by a friction fit between its peripheral sealing surface and the tube.

An inner surface of the tube defining at least a part of the sides of the first unsealed space may be formed as the inner surface of a wall of the tube, the wall comprising one or more auxiliary vents for releasing air (in addition to the release of air via the unsealed aperture of the first end of the cavity).

The height to diameter ratio of a section of the tube of the device defining the first unsealed space (and/or a section of the tube in which the plug travels) may be such as to confer stability when the device is configured to stand upright and unsupported as described herein. Additionally or alternatively, the ratio may be such as to increase the responsiveness of the plug to changes in pressure. The height to diameter ratio of a section of the tube of the device defining the first unsealed space (and/or a section of the tube in which the plug travels) may be less than or equal to 8:1, 4:1, 2:1, or 1.5:1. The height to diameter ratio of a section of the tube of the device defining the first unsealed space (and/or a section of the tube in which the plug travels) may be in a range of from about 1:4 to about 8:1, or about 1:4 to about 4:1, especially 1:2 to about 4:1; such as about 1:2 to about 2:1, especially about 1:1.5 to about 1.5:1; e.g., about 1:1.

When the internal seal is present, the height to diameter ratio of a section of the tube of the device defining the first unsealed space plus the fourth scalable space may be such as to confer stability when the device is configured to stand upright and unsupported as described herein. Additionally or alternatively, the ratio may be such as to increase the responsiveness of the plug to changes in pressure. The height to diameter ratio of a section of the tube of the device defining the first unsealed space plus the fourth scalable space may be less than or equal to 8:1, 4:1, 2:1, or 1.5:1. The height to diameter ratio of a section of the tube of the device defining the first unsealed space plus the fourth scalable space may be in a range of from about 1:4 to about 8:1, or about 1:4 to about 4:1, especially 1:2 to about 4:1; such as about 1:2 to about 2:1, especially about 1:1.5 to about 1.5:1; e.g., about 1:1.

The unsealed aperture preferably has the same or substantially the same cross-sectional shape and the same or substantially the same diameter as the plug first surface. The unsealed aperture is preferably also unobstructed. Thus, it is preferably devoid of a cap, lid, bung or other blockage. The unsealed aperture defining the first end of the cavity may be at least about 5, preferably at least about 10 times larger than the aperture of the small bore connector. One or more of these features may be used to promote venting of air from the aperture during mixing, while providing a simple and stable device.

The unsealed aperture is preferably a single unsealed aperture, as opposed to a plurality of apertures.

### The Second Sealable Space; and the Third and Fourth Scalable Spaces Thereof

The second sealable space extends from the second surface of the plug to the second end of the cavity. The second scalable (preferably, hermetically scalable) space may be configured to sealably accommodate (or may actually sealably accommodate) a drug and/or an excipient; especially a drug.

Thus, in a storage configuration of the device (i.e., during storage) the second scalable space is preferably sealed (such as being hermetically sealed). The (preferably hermetic) seal formed by the plug is preferably maintained in both the storage configuration of the device and in a mixing configuration of the device (i.e., throughout both storage and mixing). In the mixing configuration of the device (i.e., during mixing), the sealing element of the connection and scaling mechanism may be open, for exerting a positive or negative pressure through the connector, thereby to move the plug.

The second scalable space may have a volume of about 0.1 ml to about 50 ml, such as about 0.1 ml to about 20 ml, such as about 0.1 ml to about 15 ml, especially about 0.5 ml to about 12 ml. The diameter of the second sealable space (across the tube) may be in a range of from about 1 mm to about 50 mm, such as about 10 mm to about 20 mm, e.g. about 15 mm. The length of the second scalable space (along the tube) may be in a range of from about 3 mm to about 150 mm, such as about 3 mm to about 80 mm, such as about 5 mm to about 60 mm.

The second scalable space is preferably sterile (including all its surfaces, including the second surface of the plug).

As mentioned above, the second scalable space may contain an internal seal, wherein the internal seal has a first surface and a second surface and is disposed between the second surface of the plug and the second end of the device. Preferably, the internal seal spans a cross-section of the tube, wherein the first surface of the internal seal faces the second surface of the plug and the second surface of the internal seal faces the second end of the device. Preferably, a third scalable space is defined as between the second surface of the internal seal and the second end of the device. The third scalable space may be configured for sealably accommodating the excipient and/or the drug; especially the drug.

The third scalable space may have a height to diameter ratio less than or equal to 8:1, 4:1, 2:1, or 1.5:1. The third scalable space may have a height to diameter ratio in a range of from about 1:4 to about 8:1, or about 1:4 to 4:1, especially 1:2 to about 4:1; such as about 1:2 to about 2:1, especially about 1:1.5 to about 1.5:1; e.g., about 1:1.

Optionally in a storage configuration of the device, the first surface of the internal seal is flush with the second surface of the plug (without a gap therebetween). If so, preferably the third scalable space is configured for sealably accommodating the drug.

In an alternative storage configuration of the device, a fourth scalable space is defined as between the second surface of the plug and the first surface of the internal seal. The fourth scalable space may be configured for sealably accommodating the excipient or the drug; especially, the excipient. If so, preferably the third scalable space is configured for sealably accommodating the drug and the fourth scalable space is configured for sealably accommodating the excipient.

The fourth scalable space may have a height to diameter ratio less than or equal to 8:1, 4:1, 2:1, or 1.5:1. The fourth sealable space may have a height to diameter ratio in a range of from about 1:4 to about 8:1, or about 1:4 to 4:1, especially 1:2 to about 4:1; such as about 1:2 to about 2:1, especially about 1:1.5 to about 1.5:1; e.g., about 1:1.

Optionally, the internal seal is absent. When the internal seal is absent, the second space may preferably be configured for sealably accommodating excipient and/or drug; especially drug.

The cross-sectional diameter of the fourth scalable space (when present) may be greater (such as more than 1.5 times greater, more than 2 times greater, or more than 3 times greater, or such as about 1.5 to about 4 times greater) than the cross-sectional diameter of the third scalable space. The cross-sectional diameter of the first unsealed space may be greater (such as more than 1.5 times greater, more than 2 times greater, or more than 3 times greater, or such as about 1.5 to about 4 times greater) than the cross-sectional diameter of the third scalable space.

The tube of the device may comprise at least one transparent viewing window integrally formed with or assembled into the wall of the tube, for viewing into the second space; such as into the third scalable space and/or into the fourth sealable space (when the internal seal is present), especially into the third scalable space. The viewing window may permit visual inspection of the contents of the space, including to check drug integrity during storage and/or to monitor mixing. The viewing window may extend partially or entirely around the circumference of the tube. The viewing window may be formed of a material inert to drug and/or inert to excipient. The viewing window may be configured to resist clouding, staining or degradation upon contact with drug and/or with excipient.

The device may comprise a filter within the cavity. The filter may be arranged to filter fluid passing out of the second scalable space via the connector. The filter may be configured to allow the passage of a liquid excipient, but not allow the passage of a solid drug.

Optionally, the filter is provided between the connection and sealing mechanism and the second scalable space, such as between the connection and sealing mechanism and the third scalable space (when the internal seal is present). Preferably, the filter has a first surface facing the second scalable space and a second surface facing the connection and sealing mechanism. The filter may be configured to trap solid drug on its first surface. Thus, suitably, the filter may have pores sized and configured for the passage of drug dissolved in a liquid excipient, but not of solid (undissolved) drug. During mixing of a solid drug with a liquid excipient, a user may observe whether solid drug is being trapped on the first surface of the filter. When all drug is dissolved, no drug remains on the filter, informing the user that mixing is complete.

### Translation of the Plug

The plug is sealably translatable along a longitudinal axis of the tube, for reversibly changing the volume ratio of the first unsealed space to the second scalable space (such as in a mixing configuration of the device). Suitably, the device (such as in a mixing configuration) is configured for the plug to move in reversible sealed translation along the longitudinal axis of the tube. Suitably, the plug is moveable (such as in a mixing configuration of the device) in reversible sealed translation along the longitudinal axis of the tube upon the application of a positive or negative pressure via the connector of the device, such as in operation of the plunger of the syringe as defined in accordance with the second aspect of the disclosure.

The device (such as in a mixing configuration) may be configured for the reversible sealed translation of the plug along a longitudinal axis of the tube, thereby to cause turbulent mixing in the second scalable space. In methods in accordance with the present disclosure, mixing (such as mixing of a liquid and the drug) in the second scalable space may be turbulent mixing. As used herein, the term “turbulent mixing” refers to mixing of fluid (particularly, mixing of the drug and a liquid) under unbalanced forces. Suitably, “turbulent mixing” means the fluid being mixed has a Reynolds number of at least about 3500, such as at least about 4000, especially at least about 5000. Optionally, the fluid being mixed has a Reynolds number of no more than 50,000.

The device may comprise a constriction (e.g. a narrowing of the internal side walls of the tube) at the internal opening into the connection and sealing mechanism, and/or between the third scalable space and the fourth scalable space. Such a constriction may help promote turbulent flow of fluid within the second scalable space.

Preferably (when the internal seal is present) in a mixing configuration of the device, the internal seal is ruptured thereby promoting turbulent mixing of a mixture (especially, drug and excipient) in the second scalable space.

The segment of the tube along which the plug is translatable may have a substantially constant (especially, substantially circular) internal cross-section (so that the segment may, for example, be a substantially cylindrical segment). The segment may extend all the way from the first end of the cavity, defined by a (single) unsealed aperture, to the shoulder that closes the second end of the cavity.

The shoulder may be shaped to mate with the shape of the second surface of the plug.

Thus (especially as in a mixing configuration of the device), the plug may be moveable to produce an empty configuration of the device, wherein the plug is substantially flush with the shoulder at the second end of the cavity of the device, thereby reducing the volume of the second space to substantially zero.

### Upright Position of the Device

As described herein, the device may be configured to stand upright (i.e., on end) and unsupported upon a part of the tube that defines the first end of the cavity. The device preferably comprises an outwardly extending flange on the exterior of the tube at the first end, the flange being configured to support the device on a surface in an upright position (without external support, such as without leaning against another object or being held upright by the hand of a user).

The flange may extend up to a flange outer perimeter. The outermost diameter of the flange (the diameter at the flange outer perimeter) may be at least about 1.5 times, at least about 2 times or at least about 3 times the diameter of the tube. The outermost diameter of the flange may be no more than about 5 times the diameter of the tube.

Providing a flange on which the device may stand upright enables the device to sit stably on a surface during not only storage, but also during mixing. This enables easier handling by a physician, compared to a device which must be held or otherwise supported by the physician during mixing, because the device may sit stably on a surface during the mixing process.

Meanwhile, the plug may be suspended by a friction fit entirely inside the tube and spaced apart from the first end, so that the plug does not impede the upright position of the device, such as when the device is supported by the flange. This is in contrast to, for example, a traditional syringe, which is incapable of standing unsupported on its end in such a manner.

All in all, the plug may be configured to sit or may be disposed wholly inside the tube with the first surface of the plug being spaced apart from the first end of the cavity. In so doing, the plug may be supported solely by friction between the peripheral sealing surface and the tube inner surface.

Suitably, the first end of the cavity is configured as a bottom end, the second end of the cavity is configured as a top end, the first surface of the plug is configured as a bottom surface, the second surface of the plug is configured as an upper surface, and the plug is configured to receive and support the entire weight of a drug (such as at least about 1, 2, 3, 4 or 5 g of drug) resting upon its second surface (it will be understood, without the plug slipping under the weight of the drug). If so, the device preferably comprises an outwardly extending flange on the exterior of the tube at the first, bottom end, the flange being configured to support the device on a surface in an upright position. The flange may therefore be sized to support the device in this way (rather than being a small lip). The plug is preferably suspended wholly within the device solely by the friction fit described herein, being configured to receive and support the entire weight of a drug and/or excipient resting upon its second, upper, surface; it will be understood that this is without the plug inadvertently moving (e.g., slipping) within the cavity during storage.

### Connection and Sealing Mechanism

The second end of the cavity is defined by a shoulder extending inwardly to a connection and scaling mechanism, the connection and sealing mechanism comprising or consisting of a connector and a sealing element.

The connector may comprise a substantially cylindrical connector portion of the tube. The connector may comprise connecting features, such as threads or lugs, on the external and/or internal surface of said connector portion for connection to the syringe. An aperture (i.e. a bore) may extend through the connector for passage of drug and/or excipient into the sealable space, optionally via the filter. The aperture (bore) may open into the second chamber. The filter may be provided at a boundary between the connector and the second chamber. The mean diameter of the aperture of the connector is preferably at least about 5 or at least about 10 times smaller than the mean diameter of the unsealed aperture defining the first end of the cavity of the tube of the device. While the unsealed aperture defining the first end of the cavity is open to the surroundings, not being sealed, the connector is sealable (preferably hermetically sealable, or at least watertight) by the sealing element.

The mean diameter of the aperture of the connector may be adjusted in dependence on the nature of a drug to be stored and mixed. The mean diameter of the aperture may be in a range of about 1 mm to about 100 mm, such as about 1 mm to about 50 mm, such as about 1 mm to about 10 mm, especially about 3 mm to about 10 mm.

The connector of the device may be a small-bore connector, such as a hypodermic small-bore connector.

The connector of the device may be defined in accordance with ISO 80369, particularly ISO 80369-7.

The connector of the device may be a luer connector. The luer connector may be configured for forming a luer slip or a luer lock with a mating connector, preferably a luer lock. Thus, the small-bore connector is preferably a luer lock connector.

Luer lock connections are a way to mitigate accidental separation of two connectors. A male luer lock connector may typically comprise a male taper with an associated threaded skirt. A female luer lock connector may typically comprise a female taper having lugs or other protrusions to engage the male threads. When the two connectors are screwed together, the tapered surfaces may be compressed in the same manner as the taper connection; however, with the addition of the threaded coupling, the connection cannot be simply pulled apart.

Although reference is made to a male “taper” and a female “taper”, it will be understood that the device (and syringe) described herein are not limited to specific taper angles and, as such, the angle of taper (if any) may vary.

There are several types of male luer lock connector. The male luer lock connector may have a fixed skirt in which the skirt and luer taper are a single piece or it may have a swivel skirt in which the skirt and taper are separate pieces. The swivel skirt allows for the taper fit to be engaged first, and then secured with the skirt.

There are also several types of female luer lock connector. The female luer lock connector may have a rim, two or more lugs, or one or more threads on its exterior surface. Its shape is not especially limited provided it can mate with a male luer lock connector.

The connector of the device may be a male luer connector, especially a male luer lock connector; or it may be a female luer connector, especially a female luer lock connector. Preferably, if it is a luer connector, the connector of the device is a female luer lock connector.

The connector of the device may preferably be configured to mate with (more preferably, form a liquid-tight seal with) a male luer lock connector. This may be regardless of whether the connector of the device is itself a female luer lock connector as such. Such a connector may thus be a female luer lock connector; or may be a rimmed connector, threaded connector, lugged connector or other connector configured to mate with (preferably, form a liquid-tight seal with) a male luer lock connector.

When the syringe has a male luer lock connector and the connector of the device is configured to mate with a male luer lock (e.g., the connector of the device is a female luer lock connector), and the flange is present so that the device can stand upright on a flat surface during mixing, it has been found that a particularly stable mixing configuration is achieved, with a lower risk of undesirable movement (e.g. slipping or twisting) by the syringe). Thus, preferably, the flange is present, the connector of the mating connector of the syringe is a male luer lock connector, and the connector of the device is configured to mate with a male luer lock (e.g. is a female luer lock connector).

The sealing element may be or comprise any fitting configured to maintain a substantially (or wholly) sterile environment within the second space of the device. Thus, the sealing element may be or comprise a fitting configured to form an aseptic seal on, around or in the connector. It will be appreciated that a sterile environment is one devoid of any living organism, particularly microorganisms such as fungi and bacteria; a sterile environment will also be free of viruses. Sterilization may be achieved by any suitable means known in the art, such as by heating, chemical sterilisation, and/or irradiation.

The sealing element may be reusable or it may be non-reusable.

The sealing element may be a self-destructive sealing element. For example, the sealing element may be configured to collapse upon contact with a connector of a syringe, such as a mating connector of a syringe as defined in accordance with the second aspect of the disclosure. Suitable materials for the sealing element may include papers, cards, foils, silicones and rubbers. The material may be configured to collapse upon contact with a connector of a syringe.

The sealing element may be or comprise a stopper (such as a rubber or silicone stopper). The stopper may be configured to fit in the connector, especially, to be lodged inside the connector. Such a stopper may thereby form an aseptic seal in the connector. When the sealing element is or comprises a stopper, this may enable reusability of the sealing element (by removing and replacing the stopper at will). The stopper may extend, from outside the connector, into the second scalable space. The stopper may extend along a majority of the length of the connector or along the entire length of the connector. This may provide a larger contact area for improved scaling, compared to a shorter stopper. The stopper may have one or more fittings or attachments for further scaling with the connector, such as one or more lips, one or more rims, one or more clasps, or one or more threads. The stopper may extend outwardly from the connector. For example, the stopper may have a portion outside the connector for attaching to an outer surface of the connector; such as a stopper portion (e.g., a thread) configured to mate with an outer thread of a luer lock connector. Alternatively, the stopper may sit wholly inside the connector. If no part of the stopper is exposed outside the connector, this may mitigate the risk of accidentally dislodging the stopper. Additionally or alternatively, a stopper entirely internal to the connector may be further sealed over by a film configured to maintain sterility, as defined hereinbelow. The stopper may be a self-destructive stopper, in that it may be configured to give way upon the application of a connector of a syringe, such as a mating connector of a syringe as defined in accordance with the second aspect of the disclosure.

The scaling element may be or comprise a collar and a rupturable membrane, wherein the collar encircles the connector and the collar is (entirely) sealed over by the rupturable membrane thus (entirely) scaling a space enclosing the connector. Preferably, the rupturable membrane is spaced apart from the connector. When the connector has a height x and the collar has a height y, x is optionally no greater than about 3y/4, no greater than about 2y/3, no greater than about y/2, or no greater than about y/3, so as to space the rupturable membrane apart from the connector. This means that if the mating connector of the syringe as described herein is used to rupture the membrane on its way to being inserted into the connector of the device, the membrane is less likely to be entrained in the connection or otherwise contaminate the drug.

The rupturable membrane may be configured to rupture upon the application of pressure to a point or area on the membrane by a mating connector of a syringe.

The rupturable membrane may comprise weakened regions, for example having reduced thickness, arranged to preferentially break in response to pressure applied to the rupturable membrane. The weakened regions may be formed into one or more lines extending at least partly across the membrane. The weakened regions may be akin to perforations in a paper material, which allow the paper to preferentially tear along a line. In some embodiments (and provided a seal can be maintained), the weakened regions are in the form of perforations. Preferably, the rupturable membrane is divided by the weakened regions into segments (such as about 3 to about 10 segments; e.g., about 3, 4, 5 or 6 segments) meeting at a point. The segments may be configured to peel away from the point when pressure is applied to the point. This may reduce the likelihood that the membrane becomes entrained in the connector of the device or that a piece of the membrane falls into the second space of the device, especially when the pressure is applied by the mating connector of the syringe as described herein on its way to being inserted into the connector of the device.

The rupturable membrane may comprise or consist of, without limitation, a foil, plastic, rubber and/or silicone; especially silicone. The rupturable membrane may be made of a material configured to break only along weakened regions thereof and resist further perforation, especially when it is divided into segments configured to peel away from a point when pressure is applied to the point by a mating connector of a syringe as described herein.

The sealing element may be or comprise a scalable valve, especially a leaflet valve (also known as a cusp valve). The leaflet valve may be unicuspid, bicuspid, tricuspid or quadricuspid. The leaflet valve may be inside the connector. The leaflet valve may be formed of a film, such as film formed from or comprising the one or more rubbers or other polymers described herein, preferably butyl rubber, silicone or polyurethane, especially silicone. The valve may be disposed inside the connector; especially, a valve which is a leaflet valve may be disposed inside a connector which is a luer (especially, a luer lock) connector. The valve may be configured for sealing the second scalable space until the valve is opened by a syringe, such as the syringe of a kit in accordance with the second aspect of the disclosure.

Optionally a film configured to maintain sterility may be placed directly across the top of the connector. This may promote sterility in the scalable second space. The film may be peeled away prior to use or may otherwise disintegrate.

The sealing element may be or comprise one or more (even all) of: a collar with rupturable membrane; a scalable valve; a film configured to maintain sterility; and a stopper.

### The Internal Seal

Optionally in a storage configuration of the device, the internal seal separates the third scalable space from the fourth scalable space. The internal seal may suitably be a frangible internal seal. Preferably, the internal seal is a frangible internal seal configured to rupture under pressure. The internal seal may especially be configured to rupture under pressure applied via a syringe. As described herein, positive or negative pressure may suitably be applied via the mating connector of a syringe, in accordance with the second aspect of the present disclosure. The internal seal may have one or more points configured for local deformation under pressure. For example, the internal seal may comprise frangible regions (e.g. perforations) for rupture under pressure. The internal seal may be divided by frangible regions into segments (such as about 3 to about 10 segments; e.g., about 3, 4, 5 or 6 segments) meeting at a point. The segments may be configured to peel away from the point when pressure is applied to the point. This may reduce the likelihood that the internal seal becomes entrained with the drug upon rupture, especially upon rupture when pressure is applied via the mating connector of the syringe as described herein. The internal seal may be formed of a plastic, paper or foil, especially a thermoplastic elastomer film.

Thus, in a mixing configuration of the device, the internal seal may be ruptured. Switching between a storage configuration of the device and a mixing configuration of the device may comprise rupturing the internal seal. Rupturing the internal seal may be by or comprise applying a negative or positive pressure thereto, especially by injecting or withdrawing fluid from the device by means of a syringe.

The internal seal may be impermeable (to all substances). Alternatively, the internal seal may be permeable to fluids (but not to solids), especially when the internal seal is flush with the second surface of the plug in a storage configuration of the device. If so, suitably, the third scalable space is configured to accommodate (or actually accommodates) the drug in a storage configuration of the device. As a result, advantageously, during mixing drug dissolved in liquid excipient may pass back and forth through the internal seal, but during storage of solid drug in the third sealable space the drug is protected from the atmosphere by the plug (on one side) and the connection and scaling mechanism (on the other side). Optionally in this case, switching between a storage configuration of the device and a mixing configuration of the device may comprise forming the fourth scalable space between the second surface of the plug and the first surface of the internal seal, thereby providing a device in a mixing configuration. Mixing may thereby occur in the third and fourth scalable spaces.

The internal seal may be formed of or comprise inert material. It preferably excludes compounds capable of leaching out of the material. The internal seal may be formed of or comprise one or more non-leachable plastics. The internal seal may be formed of or comprise a thermoplastic polymer, such as a thermoplastic elastomer (TPE), a rubber, Butyl rubber, silicones and silicone coated rubbers. A fluoropolymer coating may be provided, which may avoid silicone oils. The internal seal may be formed of a flexible polymer coated over a rigid polymer.

The internal seal may have a thickness of about 0.01 mm to about 2 mm, such as about 0.1 mm to about 2 mm. The frangible region(s) of the internal seal may have a lower thickness, for example 0.1 mm, compared to the other regions, which may for example have a thickness of 2 mm.

### Needleless Device

The device is, suitably, a needleless device. Thus the device is configured to store and mix drugs without the use of any needle. This may reduce the sharps risk of the device, compared to conventional ampoule and needled syringe kits for storing and mixing drugs.

The device defined in accordance with the first aspect of the disclosure is not itself a syringe (it is a non-syringe device).

### Kit

In accordance with a second aspect, the present disclosure provides a kit comprising a device in accordance with the first aspect of the disclosure and a medical syringe, the syringe comprising a barrel defining a syringe cavity, the syringe further comprising a plunger moveably disposed in a first end of the syringe cavity thereby sealably closing the first end of the syringe cavity; the syringe cavity being configured for sealably accommodating fluid (especially a liquid), the barrel having an opening to the syringe cavity at a second end of the syringe cavity, the opening at the second end of the syringe cavity being defined by a mating connector configured to mate with the connector of the device, thereby establishing a fluid-tight (especially, liquid-tight) connection for reversible transfer of fluid (especially, liquid) between the syringe cavity and the second space of the device, wherein the plunger of the syringe is operable to cause the reversible sealed translation of the plug of the device along the longitudinal axis of the tube of the device, thereby reversibly changing the volume ratio of the syringe cavity to the second space of the device.

The mating connector of the syringe may be defined in dependence on the connector of the device. Thus, when the connector of the device is a hypodermic connector, so is the mating connector. When the connector of the device is a luer connector, the mating connector of the syringe is a complementary luer connector. When the luer connector of the device is a male luer connector, the luer connector of the syringe is a female luer connector. When the luer connector of the device is a female luer connector, the luer connector of the syringe is a male luer connector. The luer connectors may be configured for forming a luer slip or a luer lock, preferably a luer lock. Thus, the connector of the device and the mating connector of the syringe are preferably both luer lock connectors, for forming a luer lock. Most preferably, the connector of the device is a female luer connector and the connector of the syringe is a male luer connector. The connectors may be defined in accordance with ISO 80369, particularly ISO 80369-7.

Alternatively, the mating connector of the syringe may be defined independently of the connector of the device.

Preferably, the mating connector of the syringe is a male luer lock connector. When the syringe has a male luer lock connector and the connector of the device is configured to mate with a male luer lock (e.g., the connector of the device is a female luer lock connector), and the flange is present so that the device can stand upright on a flat surface during mixing, it has been found that a particularly stable mixing configuration is achieved, with a lower risk of undesirable movement (e.g. slipping or twisting) by the syringe). Thus, preferably, the flange is present, the connector of the mating connector of the syringe is a male luer lock connector, and the connector of the device is configured to mate with a male luer lock (e.g. is a female luer lock connector).

Optionally, the mating connector of the syringe is configured to open the sealing element of the connection and sealing mechanism before mating with the connector of the device, such as by opening the leaflet valve described herein. The leaflet valve may be openable, or (in use) opened, by the mating connector, being a mating luer lock connector, pushing open the leaflet valve, when the leaflet valve is inside the connector, being a luer lock connector, of the device.

Optionally, the fluid-tight (especially, liquid-tight) connection for reversible transfer of fluid (especially, liquid) between the syringe cavity and the second space of the device is a hermetic connection or seal (gas tight, or impervious to gas flow).

The syringe may be made of or comprise one or more plastics, such as one or more of COC, PE, PP, PVC, PET, PVDC, epoxy and polyester.

If the syringe comprises the one or more plastics, the one or more plastics (especially, COC) may form at least about 50, 60, 70 or 80% by weight of the syringe.

The material of the syringe (such as the one or more plastics) is preferably inert. It preferably excludes compounds capable of leaching out of the material, and preferably is or comprises one or more non-leachable plastics, such as one or more of non-leachable COC, PE, PP, PVC, PET, PVDC, epoxy or polyester (especially, non-leachable COC).

The material of the syringe preferably excludes glass. The exclusion of glass (such as by its replacement with one or more plastics) may reduce the sharps risk of the syringe.

Preferably, the syringe is a needleless syringe (which means the syringe has no needle). This reduces the sharps risk of the kit.

Thus, the kit may be a needleless kit. The kit may accordingly be configured for needleless drug storage and/or mixing, i.e., without the use or aid of a needle. Compared to traditional drug storage and mixing as described herein, this may significantly reduce the time and risk involved for a physician, whether in emergency or elective procedures. In one example, it may reduce the time and risk involved for a physician when the drug is or comprises hyaluronidase (especially, in solid lyophilised form) to be mixed with an excipient (such as saline).

Thus, the kit may comprise the device configured to contain (or actually containing) a drug (such as a solid lyophilised drug, especially hyaluronidase) in the second scalable space; and the syringe configured to contain (or actually containing) an excipient (which may be a liquid, such as a solution, especially saline) in the syringe cavity; wherein the kit is a needleless kit.

The kit may comprise the device configured to contain (or actually containing) a drug (such as a solid lyophilised drug) in the third scalable space; the kit further comprising the syringe (optionally, wherein the syringe is configured to contain, or actually contains, an excipient, especially a liquid excipient, such as a solution, such as saline); wherein the kit is a needleless kit.

The kit may comprise the device configured to contain (or actually containing) a drug (such as a solid lyophilised drug) in the third scalable space and/or an excipient (especially a liquid excipient, such as a solution, such as saline) in the fourth scalable space; the kit further comprising the syringe; wherein the kit is a needleless kit.

The kit may comprise the device configured to contain or actually containing an excipient (especially a liquid excipient, such as a solution, such as saline) in the second scalable space; the kit further comprising the syringe; wherein the kit is a needleless kit.

Optionally, the syringe may be provided attached to the device. Optionally, the syringe may be or may provide the sealing element of the connection and sealing mechanism of the device. The syringe nay be attached to or packaged with the drug storage and mixing device.

Thus, the kit may be or comprise the device in accordance with the first aspect of the disclosure and a medical syringe, the syringe comprising a barrel defining a syringe cavity, the syringe further comprising a plunger moveably disposed in a first end of the syringe cavity thereby sealably closing the first end of the syringe cavity; the syringe cavity being configured for scalably accommodating a fluid (especially a liquid), the barrel having an opening to the syringe cavity at a second end of the syringe cavity, the opening at the second end of the syringe cavity being defined by a mating connector mated to the connector of the device, thereby establishing a fluid-tight (especially, liquid-tight) connection for reversible transfer of fluid (especially, liquid) between the syringe cavity and the second space of the device, wherein the plunger of the syringe is operable to cause the reversible sealed translation of the plug of the device along the longitudinal axis of the tube of the device, thereby reversibly changing the volume ratio of the syringe cavity to the second space of the device. The kit may be referred to as a drug mixing system, especially when the device and syringe are mated as above (via a fluid-tight connection).

Optionally when the syringe is or provides the sealing element, a further intermediate storage seal may be disposed to separate the syringe cavity from the second space of the device. Suitably, the intermediate storage seal may be or comprise a membrane rupturable under pressure, such as when the plunger of the syringe is operated.

The portion of the tube of the drug storage and mixing device in which the plug travels (e.g. the portion of the tube defining the fourth scalable space, the unsealed space and/or the first chamber) may have an external and/or internal diameter which is greater than the external and/or internal diameter of the barrel of the syringe. The portion of the tube of the drug storage and mixing device in which the plug travels may have an external and/or internal diameter which is at least 1.25 times, 1.5 times, 1.75 times, 2 times (double), 3 times or 4 times greater than the external and/or internal diameter of the barrel of the syringe. Said diameter may be a maximum, median or mean diameter. The external diameter of the plug may be greater than the external diameter of the bung of the syringe, and the above relative sizes may also apply as between those two components.

The portion of the tube of the drug storage and mixing device in which the plug travels may have an external and/or internal cross-sectional area (in a plane transverse to the direction of travel of the plug) which is greater than the external and/or internal cross-sectional area (in a plane transverse to the direction of motion of the plunger) of the barrel of the syringe. The portion of the tube of the drug storage and mixing device in which the plug travels may have an external and/or internal cross-sectional area which is at least 1.25 times, 1.5 times, 1.75 times, 2 times (double), 3 times, 4 times or 5 times greater than the external and/or internal cross-sectional area of the barrel of the syringe. Said cross-sectional area may be a maximum, median or mean cross-sectional area. The cross-sectional area of the plug may be greater than the cross-sectional area of the bung of the syringe, and the above relative sizes may also apply as between those two components.

The internal diameter of the portion of the tube of the drug storage and mixing device in which the plug travels may be greater than the internal diameter of the connector. The portion of the tube of the drug storage and mixing device in which the plug travels may have an internal diameter which is at least 3 times, 4 times, 5 times or 6 times greater than the internal diameter of the connector. Said diameter may be a maximum, median or mean diameter.

The internal cross-sectional area of the portion of the tube of the drug storage and mixing device in which the plug travels may be greater than the internal cross-sectional area of the connector. The portion of the tube of the drug storage and mixing device in which the plug travels may have an internal cross-sectional area which is at least 5 times, 10 times, 15 times, 20 times, 25 times or 30 times greater than the internal cross-sectional area of the connector. Said cross-sectional area may be a maximum, median or mean diameter.

The device and syringe may be configured such that, when the device and syringe are mated, and the device is placed lowermost on a flat and level surface, the device and syringe may be able to be tipped by up to 10 degrees, 15 degrees, 20 degrees, 25 degrees or 30 degrees before toppling over. That is to say, it may be at least said angle before the centre of gravity of the kit falls outside the footprint of the device. It is appreciated the position of the centre of gravity will depend on the relative fullness of the syringe and device. It may be that the device and syringe are configured to be tipped by said angles without toppling even when the syringe is substantially fully filled with fluid (e.g. a fluid having a density about that of water) and the second scalable space of the device is substantially empty with the plug in its uppermost position.

In addition to or instead of the syringe, the kit may comprise a support for attaching to the device. The support may be in addition to or as an alternative to the flange of the device described herein. The support may be configured to lock onto the device, for holding the device in place upon a surface. The support may comprise a base portion adapted to rest on a surface, and a coupling element (such as a clip, clamp, socket or other mechanical connector) configured to receive and retain the device, particularly at the part of the tube that defines the first end of the cavity. The coupling element may provide a friction-fit, snap-fit, or other releasable engagement, thereby to stabilise the device, such as to prevent tipping of the device. The support may comprise a vent to allow air to flow into and out of the unsealed aperture during the mixing process when the device is received and retained by the dock.

The support may comprise a sharps disposal unit. The sharps disposal unit may comprise a sharps receptacle configured to receive and retain the needle of the syringe after use. The sharps receptacle may, for example, be a container into which the needle can be placed, the container having a closure for retaining the needle inside the container. In use, when convenient, the needle may be removed from the container and disposed of, or the whole support (or just the sharps receptacle) could be disposed of with the needle still retained in the container.

The kit may comprise the handle for removing the plug from the cavity.

### Methods and Uses

In accordance with a third aspect, the present disclosure provides a method of making a device in accordance with the first aspect of the disclosure. The method may comprise fitting the plug thereof into the cavity of the tube thereof.

Optionally, the method further comprises fitting the device with the connection and sealing mechanism, comprising or consisting of a connector and a sealing element, at the second end of the cavity defined by the tube.

Optionally, the method further comprises fitting the device with the internal seal thereby forming the third scalable space (and, if present, the fourth scalable space). Optionally, the method comprises fitting the device with the filter.

The method in accordance with the third aspect may comprise determining an amount of drug to be stored; calculating a storage volume for the determined amount of drug, thereby determining a storage height for the plug within the cavity defined by the tube; setting the plug at that storage height, suspended entirely within the cavity, with the first surface of the plug being spaced apart from the first end of the cavity, wherein the plug is suspended in the cavity solely by a friction fit between the peripheral sealing surface and an inner surface of the tube; placing drug in the second scalable space (such as in the third scalable space thereof); and sealing over the second scalable space by means of the connection and sealing mechanism comprising or consisting of a connector and a sealing element.

The variable storage height for the plug within the cavity thereby enables the storage of different amounts of drug and/or excipient in the same device, without re-manufacturing the device at a different size. Advantageously, the customisable nature of the device may mitigate or avoid air bubbles as disclosed hereinabove.

The method in accordance with the third aspect may comprise determining an amount of excipient (such as liquid, optionally a solution) to be mixed with a drug; calculating a mixing volume for the determined amount of excipient (such as liquid, optionally a solution) and drug, thereby determining a storage height for the plug within the cavity defined by the tube; setting the plug at that storage height, suspended entirely within the cavity, with the first surface of the plug being spaced apart from the first end of the cavity, wherein the plug is suspended in the cavity solely by a friction fit between the peripheral sealing surface and an inner surface of the tube; placing drug in the second scalable space (such as in the third scalable space thereof); and scaling over the second scalable space by means of the connection and sealing mechanism comprising or consisting of a connector and a sealing element.

The variable storage height for the plug within the cavity thereby enables the mixing of different amounts of excipient (such as liquid, optionally a solution) with drug in the same device, without re-manufacturing the device at a different size; for example, if the same amount of drug is to be stored but made up with a different amount of excipient (such as liquid prior to use (such as prior to injection) in dependence on patient-specific factors.

The method may comprise drying (e.g. lyophilising) a drug when within the second scalable space. The method may comprise encapsulating the drug in an encapsulation material when within the second sealable space. The method may comprise mixing the drug, when in liquid form, with an encapsulation material. The encapsulation material may, by way of example only, be gelatine. Said mixing may be performed either within or outside of the tube. During the drying, the encapsulation material may form a barrier around the drug. The encapsulation material may dissolve upon mixing of the drug and an excipient (e.g. upon reconstitution of the drug with a diluent).

In accordance with a fourth aspect, the present disclosure provides a method of making a kit in accordance with the second aspect of the disclosure, comprising bringing together the device thereof and the syringe thereof, optionally in a package. The bringing together of the device and syringe may, for example, comprise attaching them to each other and/or packaging them together in a package. The device of the package may further be configured to comprise, or may be comprising, the drug and/or the excipient, as described herein. In addition to or instead of the device being configured to comprise, or be comprising, an excipient, the syringe of the package may be configured to comprise, or may be comprising, an excipient (such as liquid, optionally a solution) in the syringe cavity thereof. The package may be a sterile package.

The method of making a kit, in accordance with the fourth aspect of the disclosure, may comprise some or all of the steps of the method in accordance with the third aspect of the disclosure, of making a device; especially the steps dependent on determining an amount of drug to be stored; and/or determining an amount of excipient (such as liquid, optionally a solution) to be mixed with drug.

In accordance with a fifth aspect, the present disclosure provides a method of using a kit in accordance with the second aspect of the disclosure, the method comprising: opening the sealing element of the device, mating the mating connector of the syringe to the connector of the device; thereby establishing a fluid-tight (especially, liquid-tight) connection for reversible transfer of fluid (especially, liquid) between the syringe cavity and the second space of the device, a drug and/or excipient (especially, drug) being accommodated in said second space, and operating the plunger of the syringe, by pushing said plunger towards the opening at the second end of the syringe cavity, causing translation of the plug of the device along the longitudinal axis of the tube of the device towards the first end of the device; or pulling said plunger away from the opening at the second end of the syringe cavity, causing translation of the plug of the device along the longitudinal axis of the tube of the device away from the first end of the device. Optionally, drug is accommodated in the third and/or fourth scalable space, especially the third scalable space. Optionally, excipient is accommodated in the third and/or fourth scalable space, especially the fourth scalable space.

Optionally, operating the plunger of the syringe causes transfer of fluid (especially, a liquid) from the syringe cavity into the second space of the device, and causes mixing of an excipient (such as a liquid provided from the syringe and/or an excipient provided from the device) and the drug to form a mixture thereof.

Optionally when the internal seal is present, operating the plunger of the syringe causes rupture of the internal seal.

When excipient is present in the fourth scalable space and drug is present in the third scalable space, rupture of the internal seal may lead to mixing of the drug and excipient to form a mixture thereof. Optionally, further mixing may be caused by retracting the plunger of the syringe towards the first end of the syringe cavity, thereby drawing mixture from the second space of the device into the syringe cavity.

Optionally, the method further comprises again operating the plunger of the syringe, by retracting said plunger towards the first end of the syringe cavity, thereby drawing mixture from the second space into the syringe cavity.

Optionally, opening the sealing element of the device is carried out by means of the mating connector of the syringe.

Optionally, the method further comprises repeating the pushing and retracting operations of the plunger of the syringe, such as pushing (followed by retracting) about 3 or more times.

The pushing and retracting operations of the plunger of the syringe preferably cause turbulent mixing of excipient (especially liquid) and drug in the second scalable space. Such pushing and retracting may cause the excipient (especially liquid) and drug mixture to have a Reynolds number of at least about 3500, such as at least about 4000, especially at least about 5000. Optionally, said Reynolds number is no more than 50,000.

Optionally, the method comprises withdrawing part (and only part) of the mixture. The method may comprise closing the sealing element of the device. The method may comprise storing the device after closing the sealing element. The method may comprise re-opening the sealing element (optionally, by means of the mating connector of the syringe). The method may comprise withdrawing another part of the stored mixture.

In accordance with a further aspect, the present disclosure provides a method of storing and mixing a drug and excipient using the drug storage and mixing device according to the first aspect of the present disclosure (or the kit of the second aspect). The method may comprise fitting the plug into the cavity and locating the plug at a predetermined position within the cavity. The predetermined position may be a position in which the plug is disposed fully inward of the first end of the cavity. The method may comprise selecting the predetermined position (e.g. from a plurality of possible positions) based on the volume of drug and/or excipient to be mixed. At the predetermined position, the volume of the second scalable space may be less than the maximum volume of the second sealable space achieved when the plug is at an end point of travel (e.g. in which the plug is flush with the first end of the tube). At the predetermined position, the volume of the second scalable space may be substantially equal to the volume of the drug and/or excipient to be mixed.

The method may comprise inserting a predetermined amount of one of the drug and excipient into the cavity, for example into the second scalable space. Said one of the drug and excipient may be inserted when the plug is at the predetermined position. The method may comprise lyophilising the drug within the cavity. The method may comprise inserting a predetermined amount of the other of the drug and excipient into the cavity, for example into the second scalable space. Said one of the drug and excipient being separated from said other of the drug or excipient by the internal seal. The method may comprise sealing the second scalable space by applying the sealing element to the connection and sealing mechanism. The second scalable space may be sealed when the plug is at the predetermined position. The method may comprise transporting the sealed device with the drug and/or excipient contained therein.

The method may comprise removing the scaling element. The method may comprise mating a syringe (e.g. a syringe as disclosed herein) to the connection and sealing mechanism to form a fluid tight seal between the cavity of the syringe and the second scalable space. The method may comprise expressing the other of the drug or diluent (if not already contained in the second scalable space) into the second scalable space via the syringe. The method may comprise rupturing the internal seal separating the drug and excipient, for example using fluid pressure applied by the syringe.

The method may comprise mixing the drug and excipient. The method may comprise, during mixing, holding the device on a surface, the first end of the device being lowermost and the syringe being uppermost. The method may comprise prior to mixing, engaging the device with the support. The method may comprise, during mixing, the device being engaged with the support. The mixing may comprise reciprocating the plunger of the syringe, and thereby causing the plug to reciprocate within the cavity under hydraulic pressure.

The method may comprise temporarily storing the mixture of drug and excipient in the second scalable space. The method may comprise extracting the mixture of drug and excipient into the syringe. The method may comprise filtering the mixture of drug and excipient using the filter during extraction into the syringe. The method may comprise disconnecting the syringe from the connector. In this aspect, reference to a/the drug may be exchanged for references to a/the first drug, and reference to a/the excipient may be exchanged for reference to a/the second drug (being different from the first drug).

In accordance with a sixth aspect, the present disclosure provides a device in accordance with the first aspect of the disclosure or a kit in accordance with the second aspect of the disclosure, for use in a method of treatment of the human or animal body by surgery or therapy.

Optionally, the method is a method of treating a vascular occlusion by administration of hyaluronidase. Vascular occlusion is the blockage of a blood vessel. It may occur upon the injection of dermal filler, especially dermal filler comprising hyaluronic acid. If a vascular occlusion is not promptly reversed, tissue necrosis may occur. The reversal of vascular occlusion caused by hyaluronic acid may be effected by injection of hyaluronidase. This must typically be carried out quickly, in an emergency procedure, when a physician may be under significant duress.

The device and kit provided in accordance with the first and second aspects of the present disclosure may facilitate easier mixing of stored solid lyophilised hyaluronidase with a saline excipient, compared to traditional methods wherein a glass ampoule of stored solid lyophilised hyaluronidase must be broken, before mixing saline into the ampoule in a pipetting action to make up hyaluronidase solution for emergency administration.

In accordance with a seventh aspect, the present disclosure provides the use of a device in accordance with the first aspect of the disclosure or a kit in accordance with the second aspect of the disclosure, in the manufacture of a medicament. Optionally, the medicament is hyaluronidase for the treatment of a vascular occlusion.

### Separability of the Parts of the Device

The device may be configured such that its parts are separable after use, for case of subsequent disposal, such as in different recycling streams. Especially, the tube may be separable from (and thus recyclable or disposable separately from) the plug of the device. This may provide for a more environmentally friendly, sustainable device. Thus, using the device, or using the kit, may include separating the plug from the tube after mixing has been effected and the device (or kit) has been substantially emptied of drug.

It will be appreciated that features described in relation to one aspect of the present disclosure may be incorporated into other aspects of the present disclosure, and vice versa.

The internal dimensions of any portion of the tube may be defined by the walls defining the internal space of said portion. To encompass instances in which sections are non-round, the “diameter” may be the equivalent spherical diameter (d_{eq}) being calculated as d_{eq}=2*sqrt (cross-sectional area/pi). When the diameter varies in a longitudinal direction, the “diameter” may be the mean diameter along the relevant length.

### DESCRIPTION OF THE DRAWINGS

Embodiments of the present disclosure are now described by way of example only with reference to the accompanying schematic drawings in which:

FIGS. 1A and 1B show a cross-sectional view and a perspective view, respectively, of a drug storage and mixing device comprising a female luer lock connector;

FIGS. 1C and 1D show a cross-sectional view and a perspective view, respectively, of a drug storage and mixing device comprising a connector comprising two lugs;

FIGS. 1E and 1F show a cross-sectional view and a perspective view, respectively, of a drug storage and mixing device comprising a connector comprising a rim;

FIGS. 2A and 2B show a cross-sectional view and a perspective view, respectively, of a drug storage and mixing device comprising a sealing element formed of collar and a rupturable membrane;

FIGS. 3A and 3B show a cross-sectional view and a perspective view, respectively, of a drug storage and mixing device comprising a sealing element formed a leaflet valve;

FIGS. 4A and 4B show a cross-sectional view and a perspective view, respectively, of a drug storage and mixing device comprising a sealing element formed a film;

FIGS. 5A and 5B show a cross-sectional view and a perspective view, respectively, of a drug storage and mixing device comprising a sealing element formed a stopper;

FIG. 6 shows a cross-sectional view of a drug storage and mixing device comprising a combination of sealing elements;

FIGS. 7A and 7C show a cross-sectional view and a perspective view, respectively, of a kit comprising a drug storage and mixing device and a medical syringe, a plunger of the syringe being in a first position;

FIGS. 7B and 7D show a cross-sectional view and a perspective view, respectively, of the kit comprising the drug storage and mixing device and the medical syringe, the plunger of the syringe being in a second position;

FIGS. 8A to 8D show cross-sectional views of different plugs for a drug storage and mixing device;

FIGS. 9 and 10 show cross-sectional views of a drug storage and mixing device comprising first and second chambers;

FIG. 11 shows a cross-sectional view of a drug storage and mixing device comprising a first and second chambers, the plug having a projection forming a stopper;

FIGS. 12 and 13 show cross-sectional views of a drug storage and mixing device comprising first and second chambers and an internal seal;

FIG. 14 shows a cross-sectional view of a drug storage and mixing device comprising a single chamber; and

FIG. 15 shows a cross-sectional view of a drug storage and mixing device comprising a drug encapsulated within a membrane.

### DETAILED DESCRIPTION

The present inventor realised there is a need to improve traditional storage and mixing devices for injectable drugs. There is a need for safer devices carrying a lower risk of sharps injuries. There is a need for devices configured for easier handling, leading in turn to improvements in the safety of both patients and clinicians. This would enable elective and emergency procedures to be carried out quickly; and would be of especial value in emergency procedures, in which time is of the essence. In particular, the inventor recognised a need for devices configured to reduce the number of steps a physician must perform in procedures that require mixing precise amounts of two or more pharmaceutical components (such as two liquids or a liquid and a solid) immediately prior to injecting the resultant mixture to a patient in need thereof. Such need may be especially significant in emergency procedures, wherein physicians may have limited time and may be under duress. A means of making elective procedures less time consuming would also be of benefit.

When pharmaceutical components must be stored separately but combined in intimate admixture immediately prior to administration by injection, there is a need for means of mixing (and administering) the components not only more quickly, but also more safely. The formation of a homogeneous mixture for injection, whether mixing two liquids or a liquid and a solid, may require the use of multiple dispensing needles in multiple steps, entailing a significant risk of needlestick injury. The inventor recognised that handling of traditional glass ampoules, particularly under duress in an emergency procedure (but also in elective procedures) may entail a significant sharps injury risk. The step of breaking the neck of a sealed glass ampoule in which a drug has been stored may lead to glass shards becoming entrained in the mixture. Meanwhile, it would be desirable to avoid the introduction of external contaminants, during both storage and mixing. There is, for example, a need for scalable devices that can be made of inert (non-permeable, non-leachable) materials, or which do not need to be made of glass. Thus, the inventor recognised a need for drug storage and mixing devices configured for not only casier but also safer handling, especially without the use of needles or other sharps in mixing.

The present disclosure seeks to solve or mitigate some or all of the aforementioned and other problems recognised by the inventor.

While the subject-matter of the present disclosure is described and illustrated below with reference to particular embodiments, it will be appreciated by those skilled in the art that the subject-matter lends itself to many different variations not specifically illustrated herein. By way of example only, certain possible variations will now be described.

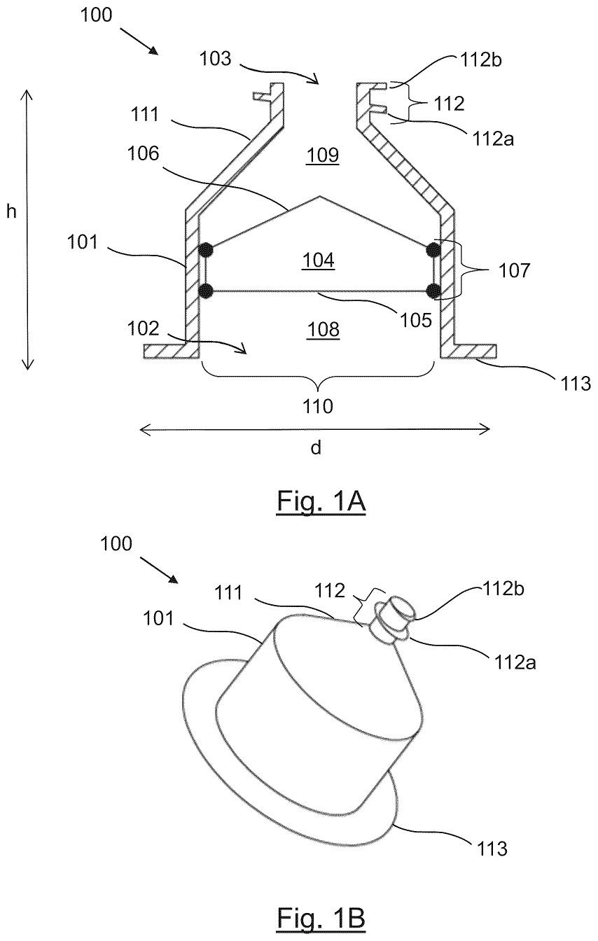

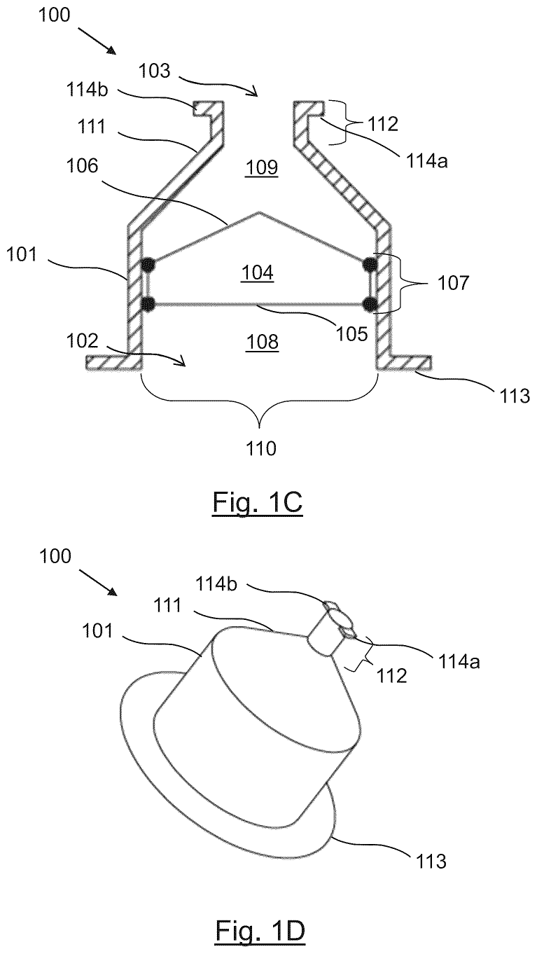

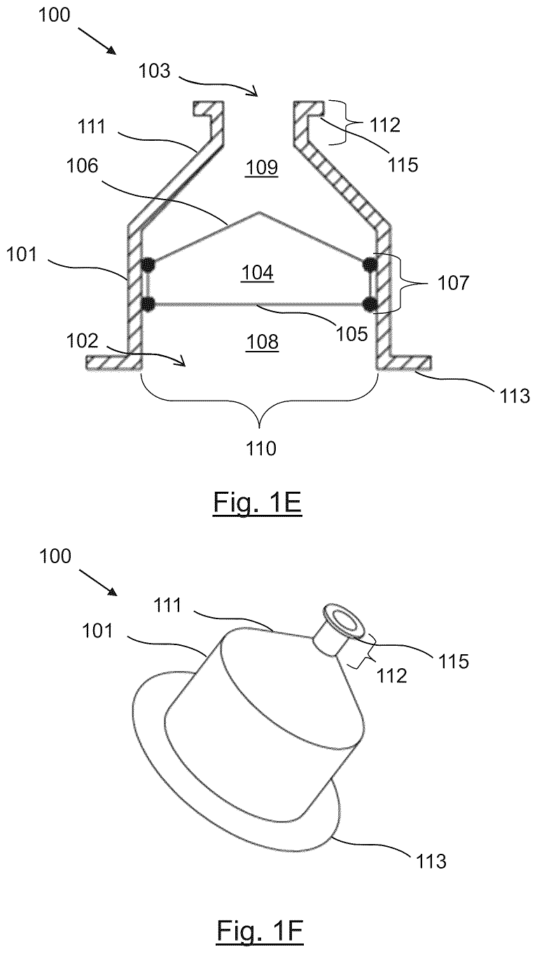

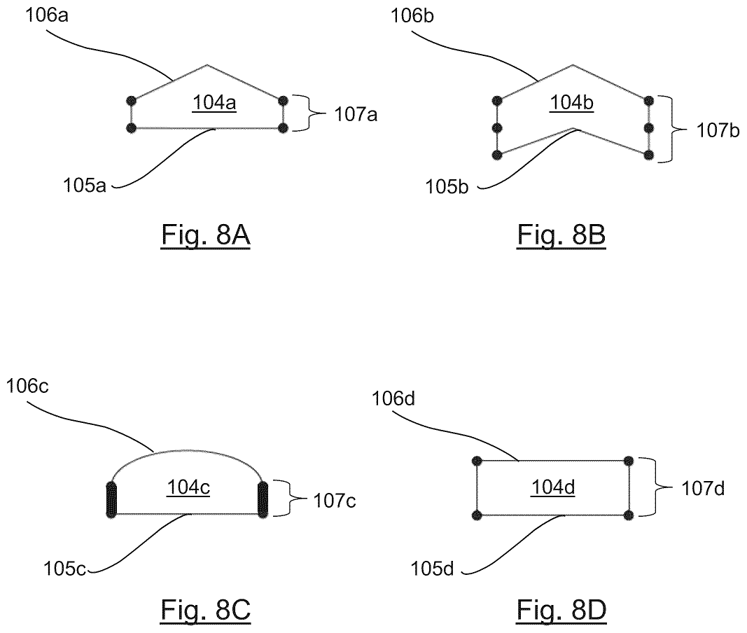

FIG. 1A shows, in cross-section, a drug storage and mixing device 100. Device 100 comprises a tube 101 defining a cavity extending from a first end 102 to a second end 103. Device 100 further comprises a plug 104 having a first surface 105, a second surface 106 and a peripheral scaling surface 107 therebetween. The peripheral sealing surface 107 forms an intermediate moveable seal within the cavity. In FIG. 1A, the peripheral scaling surface comprises a first gasket proximate the first surface of the plug and a second gasket proximate the second surface of the plug, although other configurations are possible as shown in FIGS. 8A-D. The plug 104 divides a first unscaled space 108, extending from the first end 102 of the cavity to the first surface 105 of the plug 104, from a second scalable space 109 extending from the second surface 106 of the plug 104 to the second end 103 of the cavity. The second scalable space 109 is configured for scalably accommodating a drug and/or excipient (not shown). The plug 104 is sealably translatable along a longitudinal axis of the tube 101, for reversibly changing the volume ratio of the first unsealed space 108 to the second scalable space 109. The first end 102 of the cavity is defined by an unscaled aperture 110. The second end 103 of the cavity is defined by a shoulder 111 extending inwardly to a connection and sealing mechanism comprising a connector 112 and a scaling element. In FIG. 1A, the connector 112 is shown but a sealing element is not shown. The connector 112 shown in FIG. 1A is a female luer lock connector, configured to form a fluid-tight luer lock with a mating male luer lock connector of a syringe (not shown) and having luer lock threads 112a, b. Flange 113 is provided to support the device 100 upright on a surface. The height h (measured from first end 102 to the top of connector 112) to diameter d (measured as the outermost diameter of flange 113) ratio of the tube 101 is about 1:1, imparting further stability by preventing toppling when device 100 is placed upright on a surface. As used herein, the term “upright” means the longitudinal axis of the tube is vertical (at about 90° to a horizontal surface). FIG. 1B shows the device 100 in perspective, with the same reference numerals as FIG. 1A. The luer lock threads 112a, b of connector 112 are visible in FIG. 1B.

FIG. 1C shows an embodiment of device 100 in which the connector 112 has two lugs 114a and 114b. Although different in structure to the connector having threads 112a, b of FIG. 1A, the connector 112 having two lugs 114a, b is also configured to form a fluid-tight luer lock with a mating male luer lock connector of a syringe (not shown). The remaining features of the device 100 of FIG. 1C are the same as those of the device 100 of FIGS. 1A and 1B. FIG. 1D shows the device 100 of FIG. 1C in perspective.

FIG. 1E shows an embodiment of device 100 in which connector 112 has a rim 115. Although different in structure to the connectors of preceding Figures, the connector 112 having rim 115 is also configured to form a fluid-tight luer lock with a mating male luer lock connector of a syringe (not shown). The remaining features of the device 100 of FIG. 1E are the same as those of the device 100 of preceding Figures. FIG. 1F shows the device 100 of FIG. 1E in perspective.

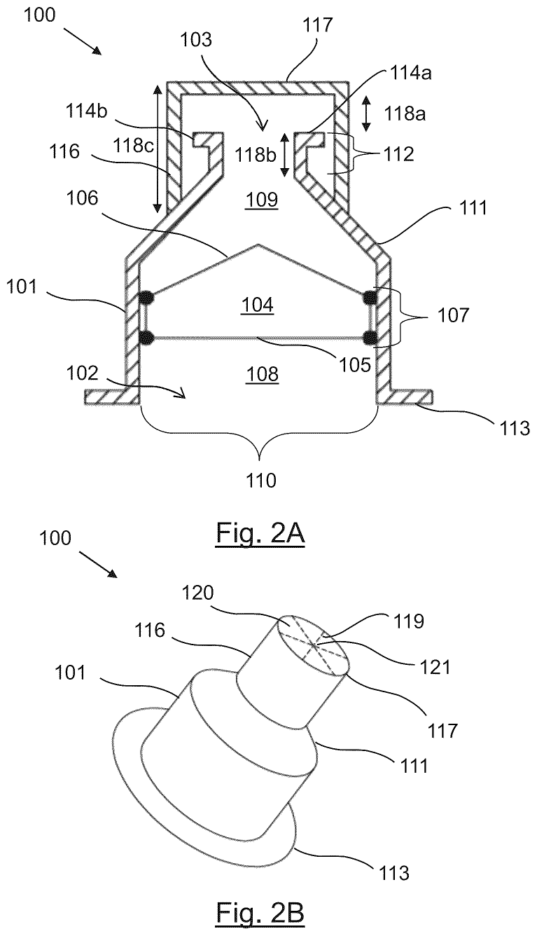

FIG. 2A shows, in cross-section, the device 100 with a sealing element. The sealing element is formed of collar 116 encircling the connector and a rupturable membrane 117 sealed over the collar 116 thus sealing a space wholly enclosing the connector 112. In FIG. 2A, the connector 112 is shown as the connector of FIGS. 1C-D, having two lugs 114a and 114b, but it will be appreciated that a different connector may be used, such as female luer lock connector having luer lock threads 112a, b of FIGS. 1A-B or the connector of FIGS. 1E-F having rim 115. Rupturable membrane 117 is spaced apart, by a height 118a, from the connector, the connector having a height 118b and the collar 116 having a height 118c. Here, height 118b is about a third of height 118c. This means that if a mating connector of a syringe (not shown) is used to rupture the membrane 117 on its way to being inserted into the connector 112, the membrane 117 is less likely to be entrained in connector 112 or otherwise contaminate the drug (not shown) housed in space 109.

As shown in perspective in FIG. 2B, rupturable membrane 117 is perforated, along perforations 119, into segments 120, meeting at a point 121. Although six segments 120 are shown (of which only one is labelled), there may be more or fewer, such as about three to about ten segments 120, meeting at point 121. In this way, when pressure is applied to point 121, the segments 120 peel to the side of and away from point 121, along perforations 119. This means that if a mating connector of a syringe (not shown) is used to rupture the membrane 117 on its way to being inserted into the connector, the membrane 117 is less likely to be entrained in the connection or otherwise contaminate the drug (not shown) housed in space 109. The rupturable membrane 117 shown here is a silicone membrane, although other suitable materials may be used.

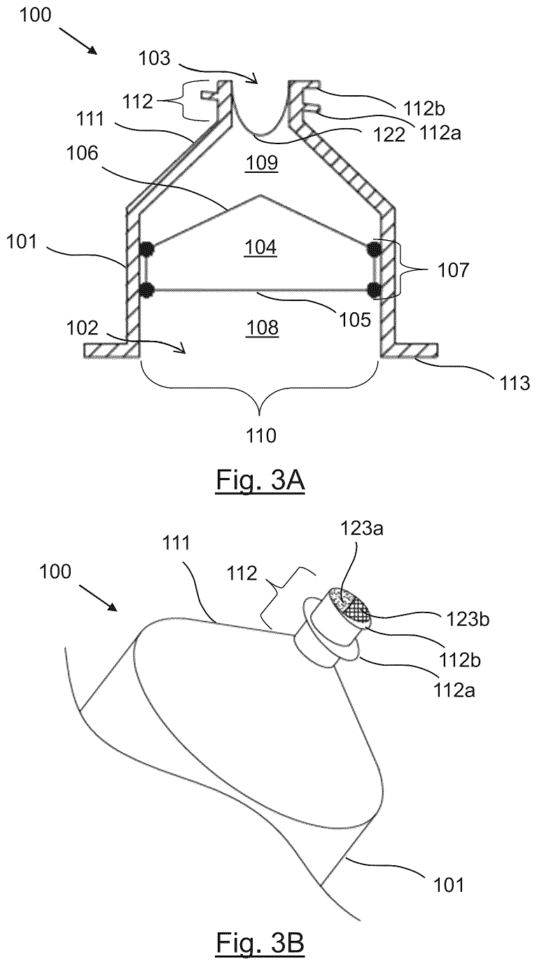

FIG. 3A shows, in cross-section, the device 100 with another sealing element. The sealing element is formed of a sealable leaflet valve (also known as a cusp valve) 122. The leaflet valve 122 shown is bicuspid, but other configurations may be used, such as a unicuspid, tricuspid or quadricuspid valve. The leaflet valve 122 shown is formed of a silicone film, although other materials may be used. The valve 122 is disposed inside the connector. In FIG. 3A, the connector 112 is a female luer lock connector in accordance with FIGS. 1A-B; but it will be appreciated that a different connector may be used when valve 122 is present, such as the connector of FIGS. 1C-D, having two lugs 114a and 114b, or the connector of FIGS. 1E-F having rim 115.

In FIG. 3B, the two leaves 123a, 123b of the bicuspid valve 122 are shown in perspective, being designated with different hatching. The valve 122 is configured for sealing the second scalable space until the valve is opened by a syringe (not shown) parting the leaves 123a, 123b thus entering the second scalable space 109.

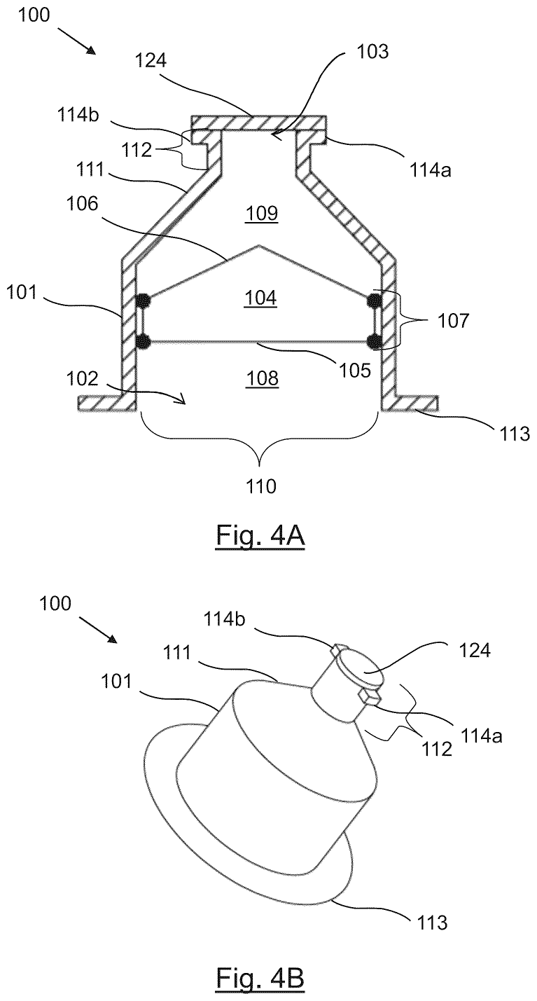

FIG. 4A shows, in cross-section, the device 100 with a yet further sealing element. The sealing element is formed of a film 124 configured to maintain sterility in space 109. Film 124 is placed directly across the top of the connector 112. In FIG. 4A, the connector 112 is shown as the connector of Figures IC-D, having two lugs 114a and 114b, but it will be appreciated that a different connector may be used, such as female luer lock connector having luer lock threads 112a, b of FIGS. 1A-B or the connector of Figures IE-F having rim 115. Film 124 may be peeled away prior to use or may otherwise disintegrate. FIG. 4B shows a perspective view of film 124 sealing across the top of the connector with lugs 114a, b.

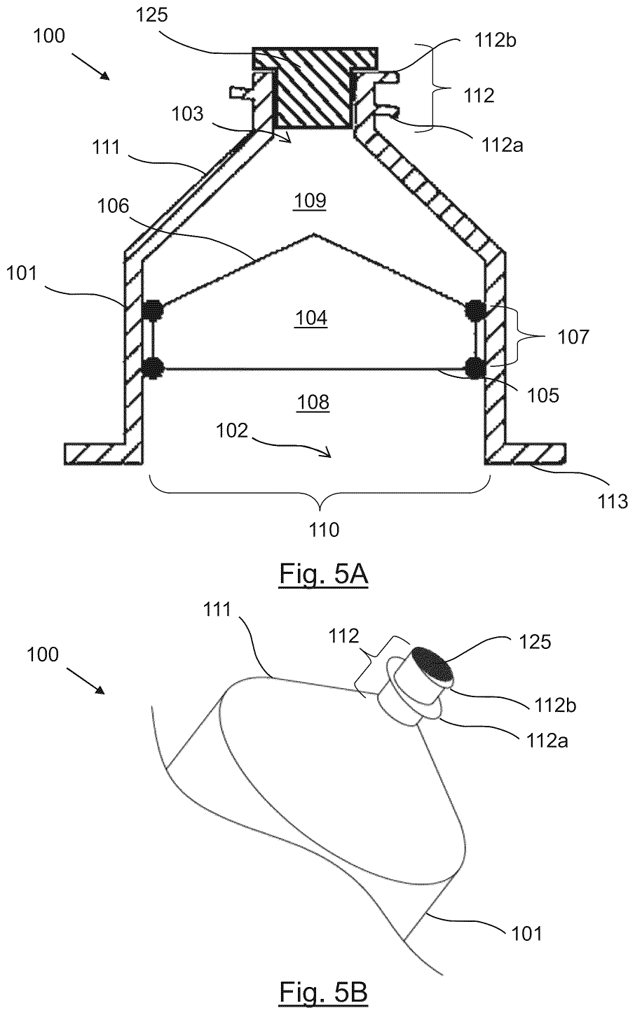

FIG. 5A shows, in cross-section, the device 100 with another sealing element. The sealing element is formed of a stopper 125 configured to maintain sterility in space 109. Stopper 125 is placed directly inside connector 112. In FIG. 4A, the connector 112 is shown as the female luer lock connector having luer lock threads 112a, b of FIGS. 1A-B, but it will be appreciated that a different connector may be used, such as the connector of Figures IC-D, having two lugs 114a and 114b, or the connector of FIGS. 1E-F having rim 115. Stopper 125 may be removed prior to mixing. FIG. 5B shows a perspective view of stopper 125 sealing the female luer lock connector 112.

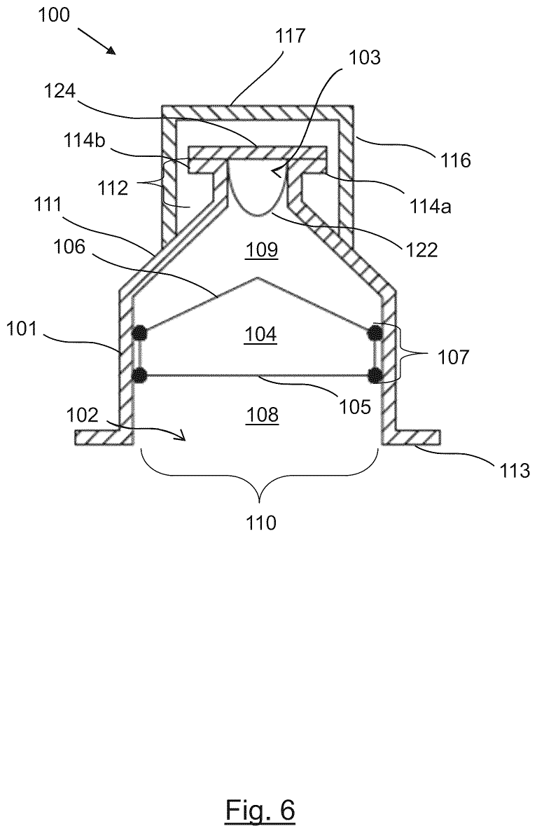

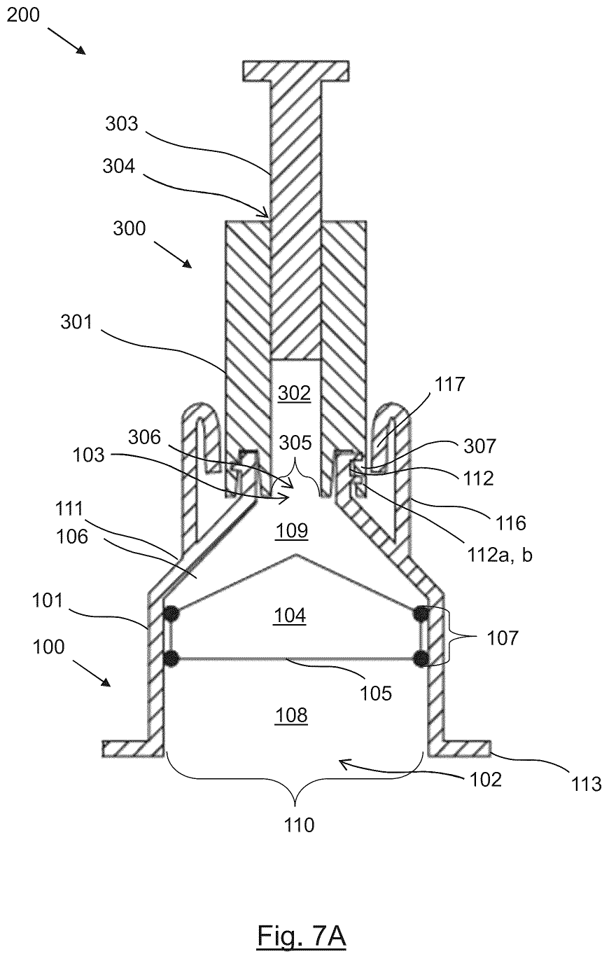

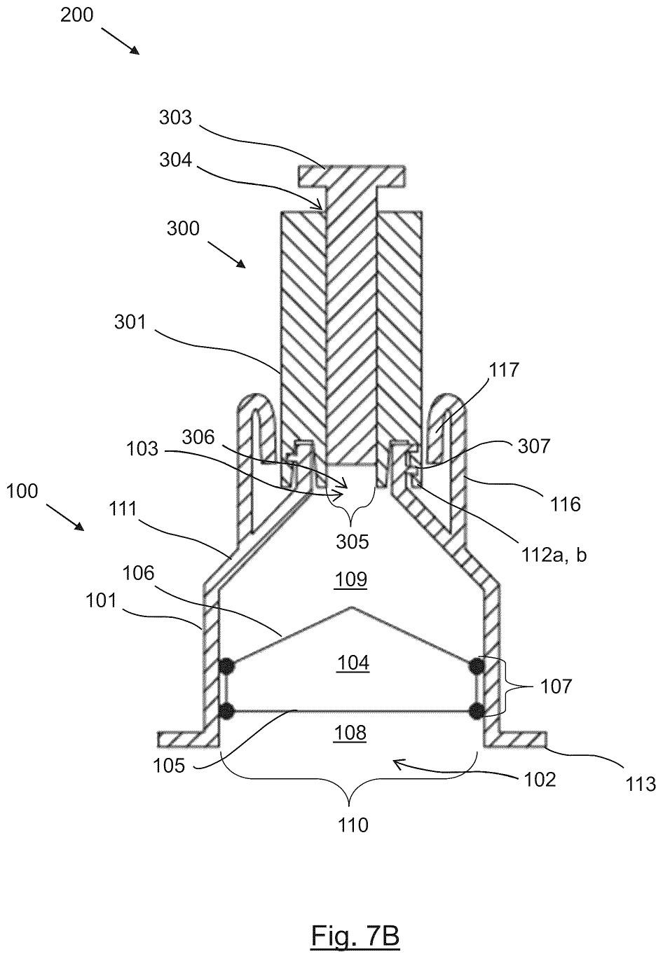

As shown in cross-section in FIG. 6, sealing elements may be combined. In FIG. 5, device 100 is equipped with collar 116, rupturable membrane 117 sealed across collar 116, leaflet valve 122 and film 124. Optionally, a combination of two of the described sealing elements may be used (without the third): for example, collar 116 with membrane 117, plus leaflet valve 122. It will be appreciated that, where leaflet valve 122 is shown in FIG. 6, a stopper, such as stopper 125 modified to be wholly internal to connector 112, could be used instead.

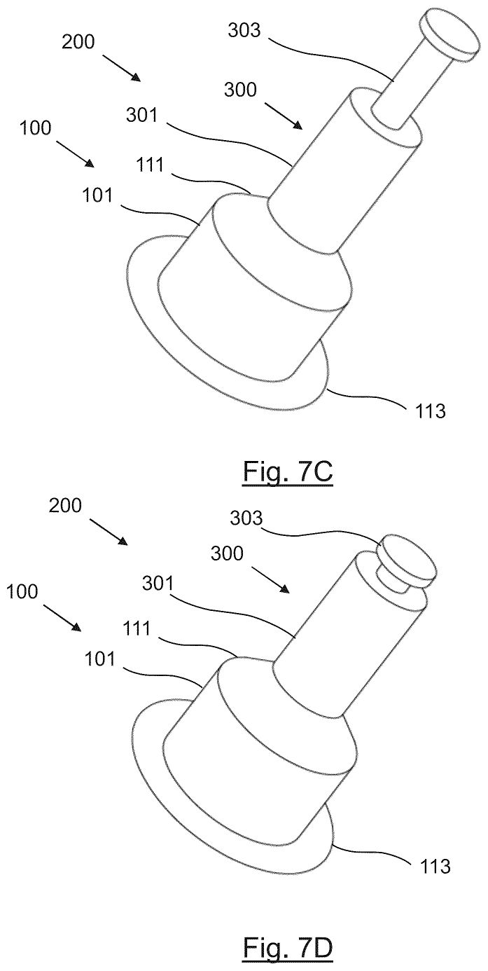

FIG. 7A shows a kit 200 comprising the device 100 and a medical syringe 300. The kit is shown assembled and ready for mixing a drug and a liquid (not shown), with syringe 300 inserted into device 100.

Syringe 300 comprises a barrel 301 defining a syringe cavity 302. Syringe 300 further comprises a plunger 303 moveably disposed in a first end 304 of the syringe cavity 302. Plunger 303 thus seals closed the first end 304 of the syringe cavity 302. The syringe cavity 302 is configured for sealably accommodating a liquid (not shown). The barrel 301 has an opening 305 to the syringe cavity 302 at a second end 306 of the syringe cavity 302. The opening 305 at the second end 306 of the syringe cavity 302 is defined by a mating connector 307 configured to mate with the connector 112 of device 100. Mating connector 307 is shown here as a male luer lock connector. In FIG. 7A, the connector 112 of device 100 is shown as the female luer lock connector of FIGS. 1A-B, having luer lock threads 112a,b; but it will be appreciated that a different connector may be used, such as the connector of FIGS. 1C-D, having two lugs 114a and 114b, or the connector of FIGS. 1E-F having rim 115. The female luer lock connector 112 having luer lock threads 112a, b engages with male luer lock connector 307 via interlocking threads, thereby establishing a liquid-tight connection for reversible transfer of liquid and drug (not shown) between the syringe cavity 302 and second space 109 of device 100. The other types of connectors, having two lugs 114a and 114b, or rim 115, would also be able to form a liquid-tight connection with male luer lock 307 by corresponding interlocking mechanisms.

Plunger 303 of syringe 300 is shown in a first position in FIG. 7A, wherein plunger 303 is spaced apart from end 306 so that cavity 302 forms a space in which excipient (especially, liquid) and drug can mix. In this position, excipient (especially, liquid) and drug can also mix in the volume of space 109. FIG. 7C shows this in perspective.

Plunger 303 can be pushed into cavity 302 resulting in a second position of plunger 303, as shown in FIG. 7B, wherein cavity 302 of syringe 303 has a substantially zero volume. In this position, mixing of drug and excipient (especially, liquid) is able to occur in space 109. FIG. 7D shows this in perspective.

Pushing and/or pulling plunger 303 causes the sealed translation of plug 104 along the longitudinal axis of tube 101. This changes the volume ratio of the syringe cavity 302 to the second space 109 of device 100. It does so without the direct application of human or other touch to plug 104: plug 104 is moved indirectly, in dependence on the movement of plunger 303. The synchronised movement of plunger 303 and plug 104 causes turbulent flow of drug and excipient (especially, liquid) between second space 109 of device 100 and syringe cavity 302, leading to mixing of drug and excipient (especially, liquid).

In a further position (not shown in FIGS. 7A and 7B), when plunger 303 is pulled as far away as possible from syringe end 306, second surface 106 of plug 104 may be pulled into a position wherein it is flush with shoulder 111 of device 100, in such a way that all drug and excipient (especially, liquid) is pulled into cavity 302 of syringe 300 during mixing. Plug 104 shown in FIGS. 7A-B has a convex second surface 106, so that it can be pulled flush with the inside wall of shoulder 111. Pushing and pulling the plunger 303 between a first position wherein cavity 302 of syringe 303 has a substantially zero volume, and another position wherein the convex second surface 106 is flush with the inside wall of shoulder 111, may allow for especially turbulent thus quick and thorough mixing.

Various different configurations are possible for plug 104. FIG. 8A shows a configuration wherein second surface 106a is convex, first surface 105a is flat, and peripheral sealing surface 107a has two gaskets, one at either end of the peripheral sealing surface. FIG. 8B shows a configuration wherein second surface 106b is convex, first surface 105b is concave, and peripheral sealing surface 107a has three gaskets, one at either end of the surface and one in the middle of the surface. FIG. 8C shows a configuration wherein second surface 106c is convex, first surface 105c is flat, and peripheral sealing surface 107c is entirely covered with a lining for forming a seal. FIG. 8D shows a configuration wherein second surface 106d is flat, first surface 105d is flat, and peripheral sealing surface 107a has two gaskets, one at either end of the surface.

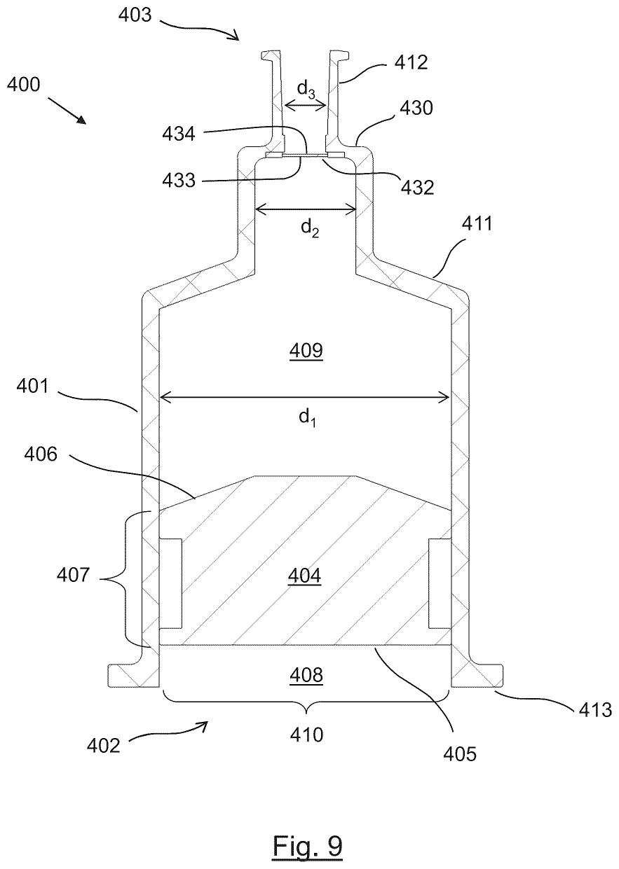

FIG. 9 shows a drug storage and mixing device 400. Similarly to device 100, the device 400 comprises a tube 401 defining a cavity extending from a first end 402 to a second end 403. A plug 404 received within the cavity has a first surface 405, a second surface 406 and a peripheral sealing surface 407 therebetween. The peripheral sealing surface 407 comprises a first gasket proximate the first surface 405 of the plug and a second gasket proximate the second surface 406 of the plug. The peripheral sealing surface 407 forms an intermediate moveable seal within the cavity. The plug 404 divides a first unsealed space 408, extending from the first end 402 of the cavity to the first surface 405 of the plug 404, from a second scalable space 409 extending from the second surface 406 of the plug 404 to the second end 403 of the cavity. The first end 402 of the cavity is defined by an unsealed aperture 410. The second end 403 of the cavity is defined by a connection and sealing mechanism comprising a connector 412 in the form of a female luer lock connector. Flange 413 is provided to support the device 400 upright on a surface.

The tube 401 comprises a stepped profile comprising a first shoulder 411 and a second shoulder 430. Between the first end 402 of the cavity and the first shoulder 411, the tube 401 has a first internal diameter d₁. Between the first shoulder 411 and the second shoulder 430, the tube 401 has a second internal diameter d₂, which is smaller than the first internal diameter d₁. In the embodiment shown, the ratio of d₁:d₂ is approximately 3:1. The first shoulder 411 acts as a stop for the plug 404, and prevents the plug 404 from travelling fully up to the connector 412 and reducing the volume of the scalable space 409 to zero. The inside of the tube 410 can thereby be taken to comprises a first chamber within which the plug 404 can travel, and a second chamber into which the plug cannot extend. The second chamber therefore provides a storage and/or mixing space which cannot be filled by the plug 404.

In some embodiments, such as those shown in FIG. 1A to IF, the tube has a substantially constant internal dimeter between the first end of the cavity and the point at which the tube narrows to a connector. In such embodiments, a stop could be provided to prevent the plug from travelling the full length of the constant diameter region. The stop thereby allows a first chamber and a second chamber to be defined within the tube, without the need for the stepped profile. The stop could, for example, be an inward projection (e.g. a rib) on the internal surface of the tube.

The connector 412 extends from the second shoulder 430 to the second end 403 of the cavity. The connector 412 has a third internal diameter d₃, which is yet smaller than the second internal diameter d₂.

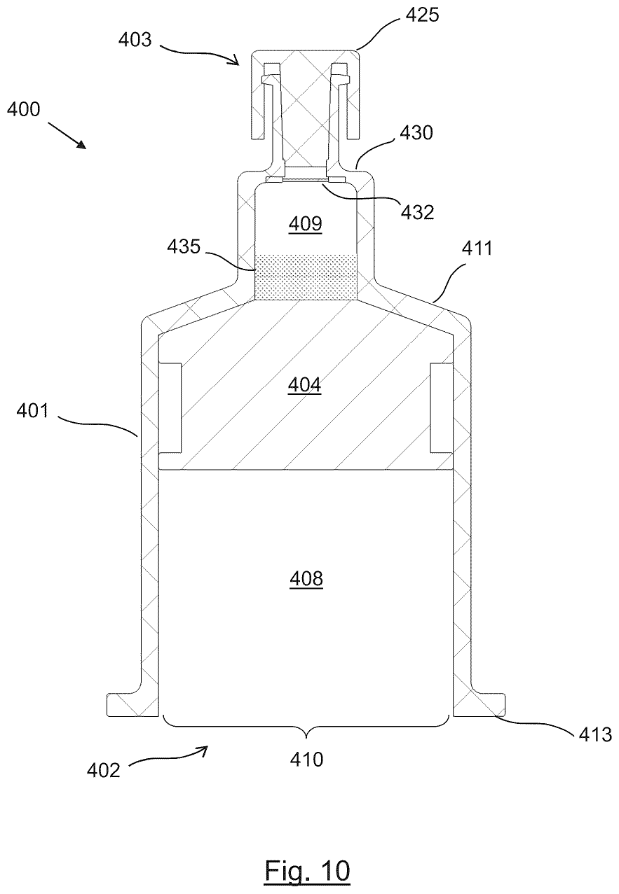

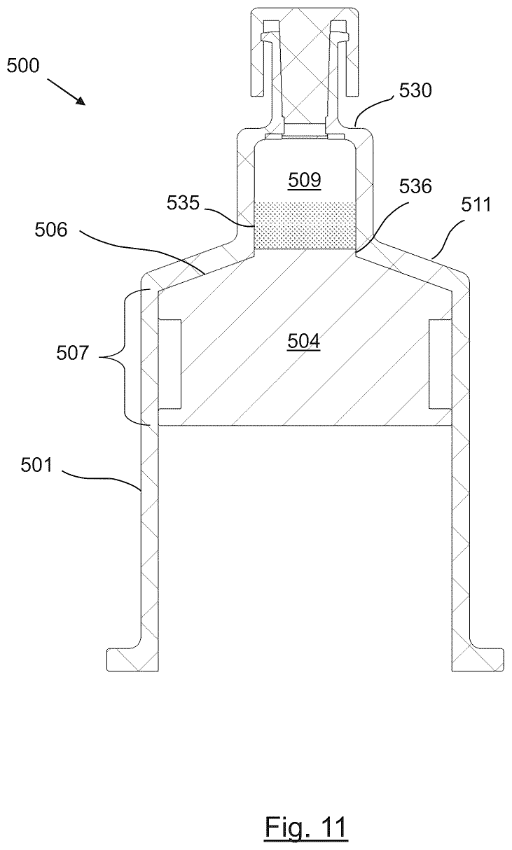

FIG. 10 shows the device 400 in a storage configuration. The plug 404 abuts the first shoulder 411 and a sealing element 425 in the form of a stopper extends into the connector 412 to seal the second end 403 of the cavity. In this configuration, the second sealable space 409 is defined entirely within the second chamber of the tube 401, the first chamber is occupied only by the plug 404 and the first unscaled space 408. A drug 435, for example in the form of a lyophilized powder, is scaled within the second scalable space 409.

A filter 432 is provided within the cavity to filter fluid passing out through the connector 412. In the storage configuration, the filter is provided between the drug 435 and the second end 403 of the cavity. The filter 432 has a first surface 433 facing the plug 404 and a second surface 434 facing the second end of the cavity 403. The filter 432 is configured to trap solid drug on first surface 433 during use. During mixing of a solid drug with a liquid excipient, a user may observe whether solid drug is being trapped on the first surface 433 of the filter 432. When all drug is dissolved, no drug remains on the filter, informing the user that mixing is complete.

In the embodiment shown, the filter 432 is provided at the second shoulder 430 and across the opening to the portion of the tube 401 which defines the connector 412. In alternative embodiments, the filter 432 could be provided relatively closer to, or further from, the second end 403 of the cavity. For example, the filter 432 could be provided within the connector 412 itself, or within the space between the opening to the connector and the first shoulder 441. It will be understood that although filter 432 is shown here in a device in accordance with FIG. 9, filter 432 could be implemented in a device as shown in any of the other Figures and is not inextricably linked to other features of FIG. 9. In alternative embodiments, the filter is integrally formed with the tube.

In use of the device 400, the scaling element 425 is removed and a syringe, for example the syringe 300, is connected to the device 400 via the connector 412. The syringe comprises a predetermined quantity of liquid excipient (e.g. a diluent). The excipient is pushed from the syringe into the device 400 and thereby combines with the drug. Pushing and pulling the plunger of the syringe in a pumping motion causes the drug and excipient to mix. The filter 432 has the effect of promoting turbulent flow within the device to assist the mixing. The shoulders 411, 430 of the tube also promote turbulent flow. The mechanical advantage provided by the relatively smaller surface area of the plunger of the syringe compared to the relatively larger surface area of the plug 404 makes it easier for the user to overcome the friction between the peripheral sealing surface 407 of the plug 404 and the internal surface of the tube 401. The device 400 is also significantly wider than the syringe, for example the external diameter of the tube 401 in the region in which the plug 404 travels may be more than twice, or more than three times, the external dimeter of the barrel of the syringe (whereupon the volume graduation lines are found). The device 400 may therefore provide a relatively stable base for effecting the pumping motion. When all the drug is dissolved, which may be indicated by no drug remaining on the filter 432, the desired quantity of the mixture is drawn up into the syringe and the syringe is disconnected from the connector 412. A needle may then be connected to the syringe for administering the mixture to a patient.

The height h (measured from first end 402 to the top of connector 412) to diameter d (measured as the outermost diameter of flange 413) ratio of the tube 401 is about 7:4.5. Whilst the aspect ratio is higher than that of the device 100, the device 400 is still sufficiently stable.

FIG. 11 shows a drug storage and mixing device 500. The device 500 is identical to the device 400 (wherein like reference numeral denote like parts), except that the second surface 506 of the plug 504 comprises a projection 536. The projection 536 is configured to form a stopper which, in the storage configuration of the device 500, projects into the region between the first shoulder 511 and the second shoulder 530 and forms a seal within that region of the tube 501. The projection may improve retention of the drug 535 within the sealable space 509, for example by reducing the likelihood of the drug 535 travelling to the peripheral sealing surface 507 of the plug 504 and getting caught between the peripheral sealing surface 507 and the internal surface of the tube 501, for example during transport of the device 500.

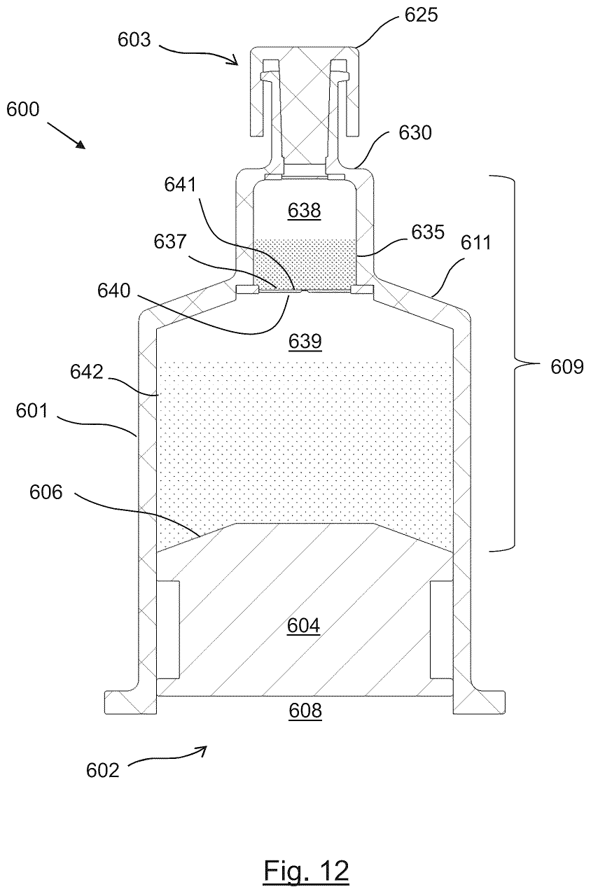

FIG. 12 shows a drug storage and mixing device 600. The device 600 is structurally identical to the device 400 (wherein like reference numeral denote like parts), aside from the differences described below. The device 600 comprises a breakable (or otherwise openable or removable) internal seal 637 arranged to divide the second sealable space 609 into a third scalable space 638 and a fourth scalable space 639. The third sealable space 638 is configured for scalably accommodating excipient and/or drug; especially drug 635. The fourth scalable space 639 is configured for scalably accommodating excipient and/or drug; especially, excipient 642 (e.g. a liquid excipient, e.g. a diluent).

Internal seal 637 spans a cross-section of tube 601. Internal seal 637 has a first surface 640 facing the second surface 606 of plug 604, and a second surface 641 facing the second end 603 of device 600. The third scalable space 638 is defined between the second surface 641 of the internal seal 637 and the second end 603 of device 600. The fourth scalable space 639 is defined between the second surface 641 of plug 604 and first surface 640 of the internal seal 637. In the embodiment shown, the internal seal 637 is provided at first shoulder 611 and across the opening to the portion of the tube 601 which has the second internal diameter d₂. The internal seal 637 is seated in a notch formed in the internal surface of the tube 601. The second surface 606 of the plug 604 is generally frustoconical. Compared to the plug 404 of device 400, the flat central surface is relatively wider such that the plug 604 can be positioned flush with, but not penetrate, the internal seal 637. In alternative embodiments, the internal seal 637 could be provided relatively closer to, or further from, the second end 603 of the cavity. For example, the internal seal 637 could be provided within the portion of the tube 601 which has the second internal diameter d₂.

FIG. 12 shows the device 600 in a storage configuration. In contrast to the storage configuration of the device 400, the plug 604 is spaced apart from the first shoulder 611 to provide space for the excipient 642. The excipient is sealably held between the plug 604 and the internal seal 637. The plug 604 is not fully towards the first end 602 of the cavity and some unsealed space 608 remains. The drug 635 is scalably held between the internal seal 637 and the sealing element 625.

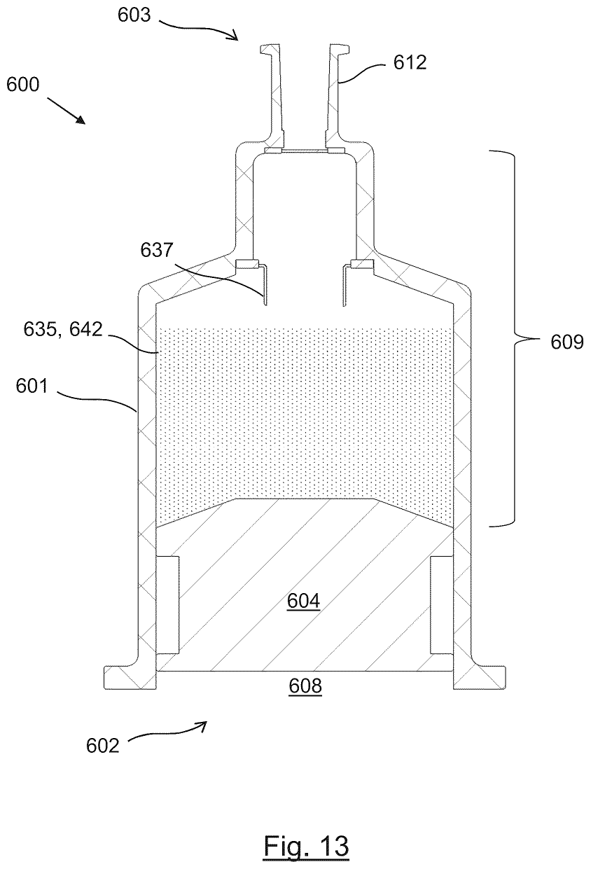

FIG. 13 shows the device 600 in a mixing configuration. In the embodiment shown, the internal seal 673 is in the form of a rupture disk. The internal seal 637 (rupture disk) has been ruptured and the drug 635 and excipient 642 have come together within the second scalable space 609 above the plug 604. In use, to rupture the internal seal 637, the sealing element 625 is removed and a syringe, for example the syringe 300, is connected to the device 600 via the connector 612. Using the syringe, fluid (e.g. air) is forced into the third scalable space 609, the fluid pressure causes the internal seal 637 to rupture. During mixing of the drug in use, the ruptured internal seal 637 may help promote turbulent fluid flow. In embodiments, the internal seal 637 comprises one or more frangible regions, for example regions of reduced thickness, to help the internal seal 637 break under fluid pressure exerted by a user.

The device 600 need not store both a drug and excipient. In an alternative storage configuration, the device 600 stores two different drugs, one in each of the third scalable space 638 and the fourth scalable space 639. The excipient may be added via the syringe. In an alternative storage configuration, the device 600 stores a drug and/or excipient in the third scalable space 638 only; the fourth scalable space 639 may be empty, or have substantially zero volume (i.e. not be present) by the plug 604 being pushed flush with the internal seal 637. In an alternative storage configuration, the device 600 stores a drug and/or excipient in the fourth sealable space 637 only, the third scalable space 638 being empty.

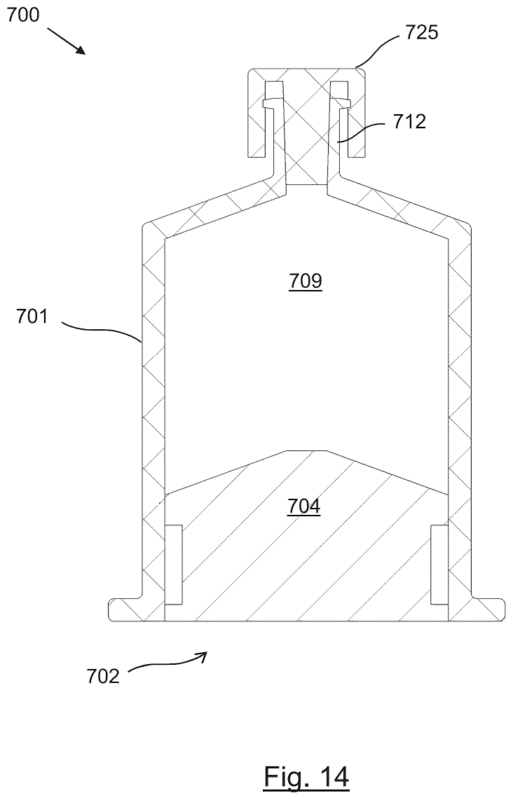

FIG. 14 shows a drug storage and mixing device 700. The device 700 has similar features to device 400, with pertinent differences described below. The tube 701 of the device 700 has a substantially constant internal dimeter between the first end 702 of the cavity and the point at which the tube narrows to a connector 712. The plug 704 can travel all the way up to the opening into the connector 712. No second chamber and no filter are provided.

The device 700 is shown in a storage configuration with sealing element 725 sealing the second end 703 of the cavity. The plug 704 is flush with the first end 702 of the cavity to achieve maximum volume of the second scalable space 709 without the plug 704 leaving the cavity. In use, the device 700 stores a drug and/or an excipient in the second scalable space 709. In some use cases, the device 700 stores only an excipient in the form of a diluent, the drug being introduced by external means, for example a syringe, prior to mixing.

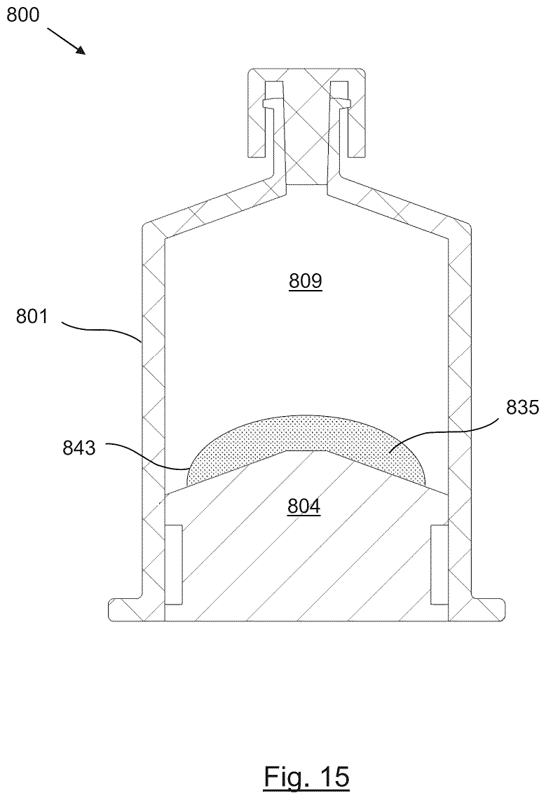

FIG. 15 shows a drug storage and mixing device 800 in a storage configuration. The device 800 has similar features to device 700, except that the drug 835 is encapsulated within a membrane 843. The encapsulated drug 835 is located on the second surface of the plug 804, and within the scalable space 809.

In embodiments, the encapsulation is achieved by mixing the liquid drug with an encapsulation material, for example gelatine. The drug is subsequently dried in situ within the tube 801, for example during a lyophilisation process. During the drying, the encapsulation material forms a barrier around the drug. The encapsulation material preferably dissolves upon mixing of the drug and an excipient (e.g. upon reconstitution of the drug with a diluent).

In embodiments, one or more of the drug storage and mixing devices described above comprise a limiter configured to limit the travel of the plug towards the first end of the tube. The limiter provides a stopping surface which blocks the plug from travelling beyond an end position, thereby setting the maximum volume of the second scalable space. The stopping surface is translatable towards and away from the second surface of the tube. The stopping surface is moved by rotating a threaded part of the limiter relative to the tube. An indexing mechanism indexes the rotation, for example by use of a ball detent (a sprung ball) riding over a ridged surface, which in turn indexes the end positions of the plug. The indexed positions are selected to correspond to different maximum volumes which are 1 ml apart. This allows the maximum volume to be adjusted in steps of 1 ml.

The tubes of the devices herein described are preferably transparent, for example being formed of a clear plastics material, such that the mixing of the drug and excipient can be easily observed. In some embodiments, for example those in which the tube is translucent or opaque, a transparent viewing window is provided into the second sealable space, and especially into the third scalable space (where present). It will be appreciated that the viewing window could be elsewhere or there could be more than one viewing window, for example a viewing window into the fourth scalable space could be provided. The viewing window can extend entirely around the circumference of tube, but this need not be the case in all embodiments.

In some embodiments, there is provided a kit comprising a storage and mixing device and a support. In embodiments, a syringe, for example the syringe 300, also forms part of the kit. The support is configured to receive and couple with the storage and mixing device (for example any of the devices described herein). The support comprises a base portion adapted to rest on a surface, and a coupling element configured to receive and retain the device. The base portion comprises a base surface which is arranged to make contact with the underlying surface. The support provides for increased stability of the device during the mixing process. In some embodiments, the base surface comprises a material (e.g. rubber) which provides for increased friction with the underlying surface to reduce the likelihood of the device sliding across the surface during mixing compared to a situation in which the device is placed directly on the underlying surface. In some embodiments, the base surface has a larger surface area than the area defined by and within the tube (including the flange, if present) of the device. This may reduce the likelihood of the device toppling over during mixing compared to the situation in which the device is placed directly on the underlying surface.

In some embodiments, the first surface of the plug comprises a connection feature in the form of a female thread, and the kit comprises a handle having an end comprising a connection feature in the form of a male thread configured to engage with the female thread such that, when the threads are connected, the handle can be used to pull the plug from the cavity.

In some embodiments, the support and device couple via an interference fit. In some embodiments, the support comprises a projection dimensioned to be received within the first end of the cavity and form an interference fit therewith. In some embodiments, the device and support each comprise complementary coupling elements configured to, when mutually engaged, retain the device on the support, for example in a manner such that the device cannot be removed from the support by pulling alone. For example, it might be that twisting of the support relative to the device is required for removal. Examples of such coupling features include complementary threads.

In embodiments, the support comprises a vent to allow air to flow freely into and out of the unsealed aperture during the mixing process when the device is received by (and optionally coupled to) the support.

In embodiments, the support comprises a sharps disposal unit comprising a closable receptacle for receiving a used needle of the syringe.

Further features in accordance with the present disclosure are set out in the following numbered clauses (not to be confused with the claims).

1. A drug storage and mixing device, the device comprising a tube defining a cavity extending from a first end to a second end; the device further comprising a plug having a first surface, a second surface and a peripheral sealing surface therebetween, the peripheral sealing surface forming an intermediate moveable seal within the cavity, the plug thereby dividing a first unsealed space extending from the first end of the cavity to the first surface of the plug, from a second sealable space extending from the second surface of the plug to the second end of the cavity, wherein the second sealable space is configured for sealably accommodating a drug, wherein the plug is sealably translatable along a longitudinal axis of the tube, for reversibly changing the volume ratio of the first unsealed space to the second sealable space, wherein the first end of the cavity is defined by an unsealed aperture, whereas the second end of the cavity is defined by a shoulder extending inwardly to a connection and sealing mechanism, the connection and sealing mechanism comprising or consisting of a connector and a sealing element.

2. The device of clause 1, wherein the plug is configured to be suspended entirely within the cavity, with the first surface of the plug being spaced apart from the first end of the cavity.

3. The device of clause 1 or clause 2, wherein the plug is configured to be suspended in the cavity solely by a friction fit between the peripheral sealing surface and an inner surface of the tube.

4. The device of any preceding clause, wherein the device comprises an outwardly extending flange on the exterior of the tube at the first end, the flange being configured to support the device on a surface in an upright position.

5. The device of any preceding clause, wherein the connector is configured to mate with a male luer lock connector.

6. The device of any preceding clause, wherein the first end of the cavity is configured as a bottom end, the second end of the cavity is configured as a top end, the first surface of the plug is configured as a bottom surface, the second surface of the plug is configured as an upper surface, and the plug is configured to receive and support the entire weight of a drug resting upon its second surface.

7. The device of any preceding clause, wherein the sealing element is or comprises a collar encircling the connector, the collar being sealed over by a rupturable membrane thus sealing a space enclosing the connector.

8. The device of any preceding clause, wherein the sealing element is or comprises a leaflet valve inside the connector.

9. The device of any preceding clause, which is a needleless device.

10. The device of any preceding clause, comprising a solid (optionally, lyophilised) drug accommodated in the second sealable space.

11. The device of any preceding clause, comprising a liquid drug accommodated in the second sealable space.

12. A kit comprising the drug storage and mixing device of any preceding clause and a medical syringe, the syringe comprising a barrel defining a syringe cavity, the syringe further comprising a plunger moveably disposed in a first end of the syringe cavity thereby sealably closing the first end of the syringe cavity; the syringe cavity being configured for sealably accommodating a liquid, the barrel having an opening to the syringe cavity at a second end of the syringe cavity, the opening at the second end of the syringe cavity being defined by a mating connector configured to mate with the connector of the drug storage and mixing device, thereby establishing a liquid-tight connection for reversible transfer of liquid between the syringe cavity and the drug-accommodating second space of the drug storage and mixing device, wherein the plunger of the syringe is operable to cause the reversible sealed translation of the plug of the drug storage and mixing device along the longitudinal axis of the tube of the device, thereby reversibly changing the volume ratio of the syringe cavity to the drug-accommodating second space of the drug storage and mixing device.

13. The kit of clause 12, which is a needleless kit.

14. The kit of clause 12 or clause 13, wherein the syringe is attached to or packaged with the drug storage and mixing device.

15. A method of making the device of any one of clauses 1 to 11, comprising fitting the plug thereof into the cavity of the tube thereof.

16. A method of making the kit of any one of clauses 12 to 15, comprising bringing together the device thereof and the syringe thereof, optionally in a package.

17. A method of using the kit of any one of clauses 12 to 15, comprising:
opening the sealing element of the drug storage and mixing device,
mating the mating connector of the syringe to the connector of the drug storage and mixing device; thereby establishing a liquid-tight connection for reversible transfer of liquid between the syringe cavity and the drug-accommodating second space of the drug storage and mixing device, a drug being accommodated in said drug-accommodating second space,
operating the plunger of the syringe, by pushing said plunger towards the opening at the second end of the syringe cavity, thereby transferring liquid in the syringe cavity into the drug-accommodating second space of the drug storage and mixing device, causing the translation of the plug of the drug storage and mixing device along the longitudinal axis of the tube of the device towards the first end of the device, and causing mixing of the liquid and the drug to form a mixture thereof, and
again operating the plunger of the syringe, by retracting said plunger towards the first end of the syringe cavity, thereby drawing mixture from the drug-accommodating second space into the syringe cavity.

18. The method of clause 17, wherein opening the sealing element of the drug storage and mixing device is carried out by means of the mating connector of the syringe.

19. The method of clause 17 or clause 18, further comprising repeating the pushing and retracting operations of the plunger of the syringe.

20. The device of clause 10 or clause 11, or the kit of any one of clauses 12 to 14 when dependent upon clause 10 or upon clause 11, for use in a method of treatment of the human or animal body by surgery or therapy.

21. The device or kit for use in a method of treatment in accordance with clause 20, wherein the method is a method of treating a vascular occlusion by administration of hyaluronidase.

22. Use of the device of any one of clauses 1 to 11 or the kit of any one of clauses 12 to 14 in the manufacture of a medicament.

23. Use of the device or kit in accordance with clause 22, wherein the medicament is hyaluronidase for the treatment of a vascular occlusion.

Where in the foregoing description, features or limitations are mentioned which have equivalents that are known, evident or foreseeable to those skilled in the art in the light of the present disclosure, then such equivalents are incorporated herein as if particularly set forth. Reference should be made primarily to the claims for determining the scope of the subject-matter of the present disclosure. The scope of protection sought by the present application further encompasses any such equivalents. It will also be appreciated by those skilled in the art that features or limitations of the disclosed subject-matter that are described as preferable, suitable, advantageous, convenient or the like may be optional and may not limit the scope of the independent claim(s) or the protection sought unless explicitly stated otherwise. Moreover, it is to be understood that such optional features or limitations, while of potential benefit in some implementations of the disclosed subject-matter, may be undesirable, and may therefore be absent or omitted in other implementations.

1. A drug storage and mixing device, the device comprising:
a tube defining a cavity extending from a first end to a second end; and
a plug having a first surface, a second surface and at least one peripheral sealing surface therebetween, the peripheral sealing surface forming an intermediate moveable seal within the cavity, the plug thereby dividing a first unsealed space extending from the first end of the cavity to the first surface of the plug, from a second sealable space extending from the second surface of the plug to the second end of the cavity,
wherein the second sealable space is configured for sealably accommodating a drug and/or an excipient,
wherein the plug is translatable along a longitudinal axis of the tube while maintaining a seal with an inner surface of the tube, for reversibly changing the volume of the second sealable space,
wherein the first end of the cavity is defined by an unsealed aperture, whereas the second end of the cavity is defined by a shoulder extending inwardly to a sealable connector.

2. The drug storage and mixing device of claim 1, wherein the plug is configured to be suspended entirely within the cavity, with the first surface of the plug being spaced from the first end of the cavity.

3. The drug storage and mixing device of claim 1, wherein the tube has a height to diameter ratio of less than or equal to 2:1.

4. The drug storage and mixing device of claim 1, wherein the tube comprises a first chamber within which the plug can travel, and a second chamber into which the plug is prevented from travelling, the second chamber providing a storage space for the storage of the drug and/or the excipient, wherein the second chamber is between the first chamber and the connector, the second chamber having a greater internal diameter than an internal diameter of the connector.

5. The drug storage and mixing device of claim 4, wherein the second chamber has a volume of at least 0.05 ml.

6. The drug storage and mixing device of claim 4, wherein the shoulder is a second shoulder, the second shoulder being between a first shoulder and the connector, the second chamber being between the first shoulder and the second shoulder.

7. The drug storage and mixing device of claim 1, wherein the second sealable space contains an openable internal seal extending across the interior of the tube, wherein the internal seal has a first surface and a second surface and is disposed between the second surface of the plug and the second end of the drug storage and mixing device; wherein the first surface of the internal seal faces the second surface of the plug and the second surface of the internal seal faces the second end of the drug storage and mixing device.

8. The drug storage and mixing device of claim 7, wherein the internal seal is in the form of a rupturable disk.

9. The drug storage and mixing device of claim 7, wherein the drug storage and mixing device comprises a storage configuration in which the drug and/or the excipient is sealed within the second sealable space, the drug and/or the excipient being sealed on one side by the internal seal.

10. The drug storage and mixing device of claim 9, wherein the drug and/or the excipient is sealed on one side by the second surface of the internal seal, and a second drug and/or excipient is sealed between the first surface of the internal seal and the second surface of the plug.

11. The drug storage and mixing device of claim 1, wherein the drug storage and mixing device comprises a storage configuration in which the drug and/or the excipient is sealed within the second sealable space, the drug and/or the excipient being sealed on one side by the second surface of the plug.

12. The drug storage and mixing device of claim 11, wherein the second surface of the plug comprises a projection configured to form an interference fit with a neck of the tube.

13. The drug storage and mixing device of claim 1, wherein the drug storage and mixing device comprises a filter within the cavity, wherein the filter is arranged to filter fluid passing out of the second sealable space via the connector, and wherein the filter is configured to prevent passage of a solid drug, but allow the passage of the drug when dissolved in a liquid excipient.

14. The drug storage and mixing device of claim 1, wherein the drug storage and mixing device comprises an outwardly extending flange on the exterior of the tube at the first end, the flange being configured to support the drug storage and mixing device on a surface in an upright position.

15. The drug storage and mixing device of claim 1, wherein the connector is configured to mate with a male luer lock connector.

16. The drug storage and mixing device of claim 1, wherein the first end of the cavity is configured as a bottom end, the second end of the cavity is configured as a top end, the first surface of the plug is configured as a bottom surface, and the second surface of the plug is configured as an upper surface, wherein the plug is configured to receive and support the entire weight of the drug, excipient, or a combination thereof resting upon the second surface of the plug.

17. The drug storage and mixing device of claim 1, comprising a solid or liquid drug accommodated in the second sealable space, wherein the drug is or comprises hyaluronidase.

18. A kit comprising the drug storage and mixing device of claim 1 and a medical syringe;
wherein the syringe comprises a barrel defining a syringe cavity, the syringe further comprising a bung moveably disposed in a first end of the syringe cavity thereby sealably closing the first end of the syringe cavity; the syringe cavity being configured for sealably accommodating a fluid, the barrel having an opening to the syringe cavity at a second end of the syringe cavity;
wherein the opening at the second end of the syringe cavity is defined by a mating connector configured to mate with the connector of the drug storage and mixing device, thereby establishing a fluid-tight connection for reversible transfer of fluid between the syringe cavity and the second space of the drug storage and mixing device,
wherein the bung of the syringe is operable to cause the reversible sealed translation of the plug of the drug storage and mixing device along the longitudinal axis of the tube of the drug storage and mixing device, thereby reversibly changing the volume ratio of the syringe cavity to the second space of the drug storage and mixing device.

19. The kit of claim 18, wherein the tube of the drug storage and mixing device comprises a portion in which the plug travels, wherein said portion has an external diameter which is at least two times, greater than the external diameter of the barrel of the syringe.

20. A method of making the drug storage and mixing device of claim 1, comprising: selecting a predetermined position of the plug within the cavity based on a volume of drug and/or excipient to be mixed, locating the plug at the predetermined position within the cavity, inserting a predetermined amount of one of the drug and excipient into the cavity, and sealing the second sealable space by applying a seal to the connector when the plug is in the predetermined position.

21. A method of using the kit of claim 18, comprising:
opening a seal sealing the connector of the drug storage and mixing device,
mating the mating connector of the syringe to the connector of the drug storage and mixing device; thereby establishing a fluid-tight connection for reversible transfer of fluid between the syringe cavity and the second space of the drug storage and mixing device, a drug and/or excipient being accommodated in said second space,
operating the plunger of the syringe, by repeatedly pushing said plunger towards and pulling said plunger away from the opening at the second end of the syringe cavity, causing translation of the plug of the drug storage and mixing device along the longitudinal axis of the tube of the drug storage and mixing device.
